(19) United States
(12) Patent Application Publication
(10) Pub. No.: US 2006/0164199 A1
(43) Pub. Date: Jul. 27, 2006

(54) Network appliance for securely quarantining a node on a network

(75) Inventors: Robert G. Gilde, Issaquah, WA (US); Xin Shen, Mercer Island, WA (US)

Correspondence Address: DARBY & DARBY P.C., P. O. BOX 5257, NEW YORK, NY, 10150-5257, US

(73) Assignee: Lockdown Networks, Inc., Seattle, WA (US)

(21) Appl. No.: 11/336,692

(22) Filed: Jan. 19, 2006

Related U.S. Application Data
(60) Provisional application No. 60/647,646, filed on Jan. 26, 2005.

(51) Int. Cl. H01F 27/24

(52) U.S. Cl. 336/234

(57) ABSTRACT

An apparatus, system, and method for managing dynamic network access control. The invention provides services and controlled network access that includes quarantining nodes so that they may be identified, audited, and provided an opportunity to be brought into compliance with a security policy. The invention is configured to detect a device seeking to join the network, and determine if the device is allowed to join the network. If the invention determines that the device is not to be allowed, the device may be quarantined using a VLAN. The suspect device may then be audited for vulnerabilities. If vulnerabilities are identified, remediation may be employed to guide the suspect device, a user, and/or administrator of the suspect device towards a resolution of the vulnerabilities, such that the device may be reconfigured for acceptance onto the network.

### CROSS-REFERENCE TO RELATED APPLICATIONS

The present application claims priority from provisional application Ser. No. 60/647,646 entitled “Network Applicance for Securely Quarantining a Node on a Network,” filed on Jan. 26, 2005, the benefit of the earlier filing date of which is hereby claimed under 35 U.S.C. § 119 (e), and which is further incorporated by reference.

### FIELD OF THE INVENTION

The present invention relates to network security, and more particularly, but not exclusively, to enabling enforcement of access control on a network.

### BACKGROUND OF THE INVENTION

Businesses are deriving tremendous financial benefits from using the internet to strengthen relationships and improve connectivity with customers, suppliers, partners, and employees. Progressive organizations are integrating critical information systems including customer service, financial, distribution, and procurement from their private networks with the Internet. The business benefits are significant, but not without risk. Unfortunately, the risks are growing.

In response to the growing business risks of attacks, potentials for legal suits, federal compliance requirements, and so forth, companies have spent millions to protect the digital assets supporting their critical information systems. In particular, many companies have recognized that the first security barrier to their business's information systems is their access control system.

Access control pertains to an infrastructure that is directed towards enforcing access rights for network resources. Access control may grant or deny permission to a given device user, device or node, for accessing a resource and may protect resources by limiting access to only authenticated and authorized users and/or devices. Therefore, there is a need in the industry for improved access control solutions. Thus, it is with respect to these considerations, and others, that the present invention has been made.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Description of the Preferred Embodiment, which is to be read in association with the accompanying drawings, wherein:

FIG. 1 illustrates one embodiment of an overview information flow employing a network access control appliance (NACA);

FIG. 2 illustrates one embodiment of an overview of a possible deployment architecture employing at least one NACA;

FIG. 3 illustrates one embodiment of one topology of an overview of a possible deployment architecture employing the NACA;

FIGS. 4-18 illustrates embodiments of a process for enabling a new device to seek access to a network;

FIG. 19 one embodiment that may be used to summarize the process embodied by FIGS. 4-18;

FIG. 20 illustrates one embodiment of an internal architecture;

FIG. 21 illustrates one embodiment of an architecture employing a switch adaptation layer (SAL);

FIG. 22 illustrates a logical flow diagram generally showing one embodiment of a process for managing access control;

FIG. 23 illustrates a logical flow diagram generally showing an alternate embodiment of a process for managing access control;

FIG. 24 illustrates one embodiment of an overview architecture for use with a NACA;

FIGS. 25-26 illustrate embodiments of an overview architecture for managing a policy database; and

FIG. 27 illustrates one embodiment of a network appliance that may be included in a system implementing the invention, in accordance with the present invention.

### DETAILED DESCRIPTION OF THE INVENTION

The present invention now will be described more fully hereinafter with reference to the accompanying drawings, which form a part hereof, and which show, by way of illustration, specific exemplary embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. Accordingly, the present invention may take the form of an entirely hardware embodiment, an entirely software embodiment or an embodiment combining software and hardware aspects. The following detailed description is, therefore, not to be taken in a limiting sense.

Throughout the specification and claims, the following terms take the meanings explicitly associated herein, unless the context clearly dictates otherwise. The phrase “in one embodiment” as used herein does not necessarily refer to the same embodiment, though it may. As used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

As used herein, the term node refers to virtually any computing device that is capable of connecting to a network. Such devices include, but are not limited to, personal computers, desktop computers, multiprocessor systems, mobile computing devices, microprocessor-based or programmable consumer electronics, network PCs, servers, network appliances, cellular phones, PDAs, or the like. Such devices may employ a wired and/or a wireless mechanism to connect to the network.

As used herein, the term Virtual Local Area Network (VLAN) Assignment Protocol (VLAP) refers to various mechanisms useable by a network device, such as a switch, router, bridge, client, server, or the like, to request that a particular VLAN be employed for use in sending and/or receiving a network packet. In one embodiment, the network packet may be a request to a server. The server may use a policy, look-up, or the like, to determine the VLAN with which to respond. Thus, in one embodiment, a VLAP client includes client devices that are configured to employ VLAP, while a VLAP server includes server devices that are configured to employ VLAP. The various mechanisms may include, but are not limited to, RADIUS MAC authentication, VLAN Membership Policy servers (VMPS), or the like.

Briefly stated, the present invention is directed towards an apparatus, system, and method for managing dynamic network access control. In one embodiment, the invention enables management of network access control at a network switch port level. The invention provides services and controlled network access that includes quarantining nodes so that they may be identified, audited, and provided an opportunity to be brought into compliance with a security policy, or the like. The invention is configured to detect a device seeking to join or otherwise access the network, identify a switch port that the device is attempting to connect to, and determine if the device is authentic and authorized to join the network. In one embodiment, the network may be an intranet, such as an enterprise's intranet, or the like. If it is determined that the device is unauthorized and/or unauthentic, the device may be quarantined. In one embodiment, the suspect device is quarantined using, for example, a Virtual Local Area Network (VLAN). The act of quarantining the suspect device may also be explained to a user of the suspect device, allowing the user and/or device to be identified and registered. The suspect device may then be audited to determine if there are vulnerabilities that might further prevent the device from connecting to the network. If vulnerabilities are determined, in one embodiment, remediation action may be employed to guide the suspect device, user, and/or administrator of the suspect device towards a resolution of the vulnerabilities, such that the device may be reconfigured for acceptance onto the network.

Moreover, the network includes any computing communication infrastructure that may be configured to couple one computing device to another computing device to enable them to communicate. Such networks are enabled to employ any form of computer readable media for communicating data from one electronic device to another. Generally, such networks can include the Internet in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router acts as a link between LANs, enabling messages to be sent from one to another. Also, communication links within LANs can include, for example, twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art. Furthermore, remote computers and other related electronic devices can be remotely connected to either LANs or WANs via a modem and temporary telephone link.

Networks may further employ a plurality of access technologies including 2nd (2G), 3rd (3G) generation radio access for cellular systems, WLAN, Wireless Router (WR) mesh, or the like. Access technologies such as 2G, 3G, and future access networks may enable wide area coverage for mobile devices, such as a mobile device with various degrees of mobility. For example, such networks may enable a radio connection through a radio network access such as Global System for Mobil communication (GSM), General Packet Radio Services (GPRS), Enhanced Data GSM Environment (EDGE), Wideband Code Division Multiple Access (WCDMA), or the like. In essence, such networks may include virtually any wireless and/or wired communication mechanism by which data may travel between one computing device and another computing device.

The media used to transmit data in communication links as described above illustrates one type of computer-readable media, namely communication media. Generally, computer-readable media includes any media that can be accessed by a computing device. Computer-readable media may include computer storage media, communication media, or any combination thereof. Additionally, communication media typically embodies computer-readable instructions, data structures, program modules, or other data in a modulated data signal such as a carrier wave or other transport mechanism and includes any data delivery media. The terms “modulated data signal,” and “carrier-wave signal” includes a signal that has one or more of its characteristics set or changed in such a manner as to encode data, instructions, data, or the like, in the signal. By way of example, communication media includes wired media such as twisted pair, coaxial cable, fiber optics, wave guides, and other wired media and wireless media such as acoustic, RF, infrared, and other wireless media.

In one embodiment, the invention is directed towards providing protection for substantially every node from substantially every other node on an internal network (e.g., intranets), in part, by preventing unauthorized or vulnerable nodes from fully connecting to the internal network. The invention may employ an apparatus, such as a network appliance, to perform network access enforcement.

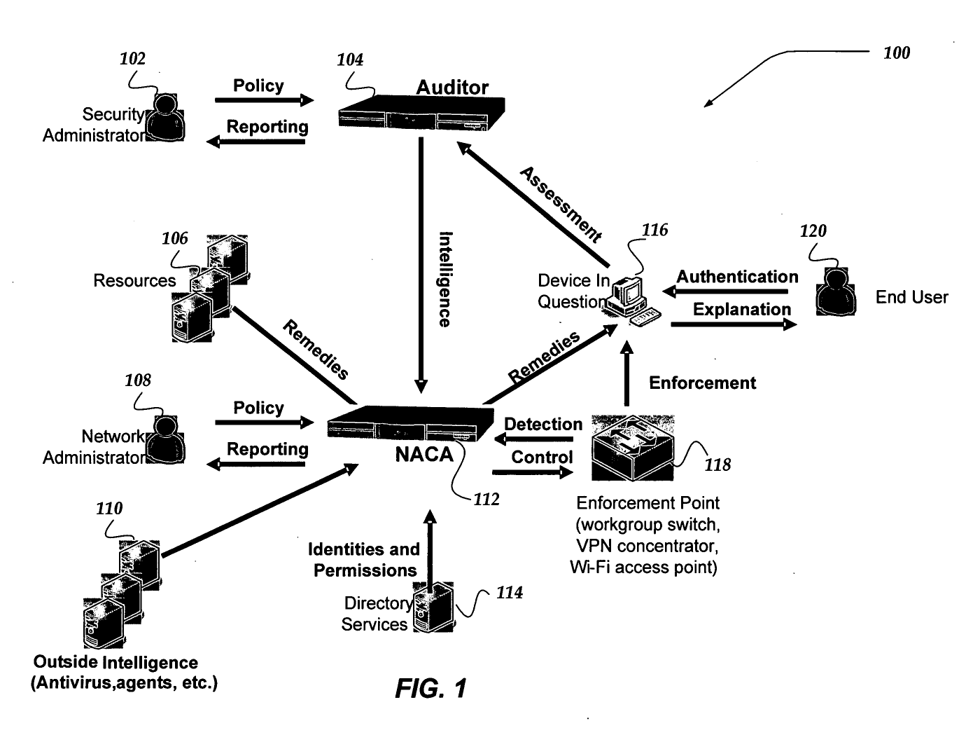

FIG. 1 illustrates one embodiment of an overview information flow employing a network access control appliance (NACA). It is important to note, however, that while NACA is configured as a network appliance, the invention is not so limited, and the invention may employ virtually any implementation, including a server, or the like. However, for ease of illustration, the invention is shown using a network appliance.

As shown in the figure, system 100 includes security administrator 102, auditor 104, resources 106, network administrator 108, outside intelligence 110, NACA 112, directory services 114, enforcement point 118, device in question 116, and end user 120.

Security administrator 102 is in communication with auditor 104. Auditor 104 is in communication with NACA 112 and device in question 116. NACA 112 is also in communication with resources 106, network administrator 108, outside intelligence 110, directory services 114, enforcement point 118, and device in question 116. End user 120 is in communication with device in question 116. Device in question 116 is in further communication with enforcement point 118.

Device in question 116 may include virtually any computing device that is configured to receive and to send information over a network. Such devices may include portable devices such as, cellular telephones, smart phones, display pagers, radio frequency (RF) devices, infrared (IR) devices, Personal Digital Assistants (PDAs), handheld computers, wearable computers, tablet computers, integrated devices combining one or more of the preceding devices, or the like. Device in question 116 may also include other computing devices, such as personal computers, multiprocessor systems, microprocessor-based or programmable consumer electronics, network PCs, or the like. As such, device in question 116 may range widely in terms of capabilities and features. For example, a client device configured as a cell phone may have a numeric keypad and a few lines of monochrome LCD display on which only text may be displayed. In another example, a web-enabled client device may have a touch sensitive screen, a stylus, and several lines of color LCD display in which both text and graphics may be displayed. Moreover, the web-enabled client device may include a browser application enabled to receive and to send wireless application protocol messages (WAP), and/or wired application messages, or the like. In one embodiment, the browser application is enabled to employ HyperText Markup Language (HTML), Dynamic HTML, Handheld Device Markup Language (HDML), Wireless Markup Language (WML), WMLScript, JavaScript, EXtensible HTML (xHTML), Compact HTML (CHTML), Voice XML, or the like, to display and send a message.

Device in question 116 also may include at least one client application that is configured to receive content from another computing device. The client application may include a capability to provide and receive textual content, graphical content, audio content, alerts, messages, notifications, or the like. Moreover, device in question 116 may be further configured to communicate a message, such as through a Short Message Service (SMS), Multimedia Message Service (MMS), instant messaging (IM), internet relay chat (IRC), mIRC, Jabber, Enhanced Messaging Service (EMS), text messaging, Smart Messaging, Over the Air (OTA) messaging, or the like, between another computing device, or the like.

Enforcement point 118 may include virtually any computing device that is configured to control the flow of network traffic. As shown, enforcement point 118 may include a network switch, an enterprise switch, a workgroup switch, a Virtual Private Network (VPN) concentrator, a Wi-Fi access point, or the like. Enforcement point 118 may accept Simple Network Management Protocol (SNMP) requests to enable the control of the flow of network traffic. Enforcement point 118 may also provide detection of the flow of network traffic. As shown, NACA 112 provides controls to enforcement point 118, and enforcement point 118 provides detection information to NACA 112. Also as shown, enforcement point 118 provides network traffic enforcement information, such as Dynamic Host Configuration Protocol (DHCP) information to device in question 116. The enforcement information may enable device in question 116 to route its network traffic appropriately.

End user 120 may include virtually any computing device that is configured to receive and to send information over a network. End user 120 may also include a user in control of the computing device, wherein the user may be enabled to direct the resources and operations of another computing device. As shown, end user 120 may provide such directions and operations to device in question 116. In one embodiment, end user 120 may be a computing device enabled by user to provide directions and operations to device in question 116.

Resources 106 represent virtually any computing device that is configured to provide remediation information over a network. Resources 106 may include a database server, a file server, or the like. As shown, resources 106 may provide remediation information to NACA 112. However, resources 106 are not limited to merely providing remediation information. For example, resources 106 may also be configured to operate as website servers. However, resources 106 are not limited to web servers, and may also operate a messaging server, a File Transfer Protocol (FTP) server, a database server, content server, or the like. Additionally, each of resources 106 may be configured to perform a different operation. Thus, for example, one of resources 106 may be configured as a messaging server, while another of resources 106 may be configured as a database server. Moreover, while s resources 106 may operate as other than a website, they may still be enabled to receive an HTTP communication. Devices that may operate as resources 106 include personal computers, desktop computers, multiprocessor systems, microprocessor-based or programmable consumer electronics, network PCs, servers, or the like. Outside intelligence 110 represents virtually any computing device that is configured to provide network intelligence information over a network, including, but not limited to, antivirus information, security agents, security patches, updates, or the like. As shown, outside intelligence 110 may provide such information to NACA 112.

Directory services 114 represent virtually any computing device that are configured to provide identity and permission information about a device, network and/or user over a network. As shown, directory services 114 may provide such information to NACA 112.

Auditor 104 represents virtually any computing device that is configured to perform a security assessment (audit) of device in question 116, and provide intelligence about device in question 116. In one embodiment, the audit may be performed periodically, on demand, or based on a configuration and/or detection of an event, or the like. As shown, auditor 104 may provide such intelligence about device in question 116 to NACA 112.

Security administrator 102 may include virtually any computing device that is configured to receive and to send information over a network. System administrator 102 may also include a user in control of the computing device, wherein the user may have permissions to provide security information about a device, network, or the like. In one embodiment, security administrator 102 may be a computing device enabled by a user to provide such security information.

Network administrator 108 may include virtually any computing device that is configured to receive and to send information over a network. Network administrator 108 may also include a user in control of the computing device, wherein the user may have permissions to provide information about a network security, network topology, configuration, or the like. In one embodiment, network administrator 108 may be a computing device enabled by a user to provide such networking information.

NACA 112 may include virtually any computing device that is configured to determine whether a new device may gain access to a network. As shown, NACA 112 is configured to interface to directory services 114 to determine authorization of a user and/or device. NACA 112 may detect a new device attempting to connect to the network. As illustrated, the new device may be device in question 116. In one embodiment, NACA 112 detects access attempts and manages access control at enforcement point 118. In one embodiment, NACA 112 may detect access attempts and manage access control at the switch port level.

NACA 112 may quarantine the new device/suspect node that is not authorized to connect to the network. NACA 112 is not constrained to manage access control based solely on device authorization, however. For example, NACA 112 may determine to quarantine a new device/suspect node based on a user not being authorized, a device not having been audited, or audited within a defined time period, an audit result/intelligence that does not conform to a policy, and/or based on virtually any other intelligence about a device, and/or user that may indicate policy nonconformance. In one embodiment, NACA 112 may determine to quarantine a new device/suspect node based on end user 120 not being authorized to connect to the network, access a resource, or the like. In one embodiment, NACA 112 may receive the policy from auditor 104, security administrator 102, or the like. NACA 112 may also receive intelligence about a device, and/or user that may indicate policy nonconformance from outside intelligence 110.

NACA 112 may be configured to operate, in one embodiment, providing a policy that defines which sites/servers or the like, a quarantined device may access. NACA 112 may operate with virtually any of a variety of switches, routers, gateways, or the like, to securely quarantine the device. In one embodiment, NACA 112 may employ an enterprise switch to quarantine the suspect device. However, NACA 112 does not require most switches to have updated hardware or firmware. In another embodiment, NACA 112 may quarantine the suspect node by employing Enforcement Point 118.

NACA 112 may redirect quarantined devices, such as device in question 116, to a “friendly” web site, where a user, device, and/or the like, may register, schedule an audit, find audit results/intelligence, and/or receive remediation information. In one embodiment, NACA may redirect quarantined devices to resources 106, which may provide remediation information.

NACA 112 may also be configured to provide a single point of control and reporting for an entire enterprise, while remaining massively scalable. NACA 112 is further configured to be easy to deploy and manage, at least in part, because it does not require agents. NACA 112 recognizes that use of agents may result in decreased security for a variety of reasons, including, because they may require compatibility testing for critical systems, may be accidentally or intentionally disabled, may be cumbersome to deploy and maintain, unsuitable for guests, as well as potentially being unavailable for every type of device, operating system, or the like. However, NACA 112 is capable of receiving information from an agent when one is available.

Moreover, NACA 112 may operate with other protection initiatives. Additionally, because in one embodiment, it uses switches to enforce quarantine at OSI layer 2, rather than relying on DHCP, NACA 112 may increase security over more traditional initiatives.

NACA 112 may be further configured to provide intelligence to wireless products, thereby preventing rogue access points on a network. While a firewall may be directed towards blocking external threats to a network, NACA 112 further blocks internal as well as external threats. In one embodiment, NACA 112 may provide a VPN-like access control to virtually an internal port.

NACA 112 may be configured to verify that such applications as antivirus, firewalls, spyware detectors, or the like, are installed, running, properly configured, and kept up to date before letting a device on a network. In one embodiment, NACA 112 may receive such intelligence from outside intelligence 110.

NACA 112 may also ensure that a patch management product is operational and has successfully performed its actions upon a device. In one embodiment, NACA 112 can provide restricted access to quarantined devices so that patches can be deployed onto the device before joining the network.

NACA 112 may employ auditor 104 to perform an assessment of a device in question, and provide intelligence to NACA 112. In one embodiment, auditor 104 may be an auditor network appliance, device, or the like. NACA 112 is not constrained to receiving intelligence from an auditor, however. NACA 112 may receive intelligence about the network, device in question, or the like, from virtually any source, including an anitvirus application, firewall, spyware detector, and even an agent. In one embodiment, NACA 112 may receive such intelligence from outside intelligence 110. NACA 112 may employ policies provided by an administrator, such as security administrator 102 or network administrator 108, and to provide reports to those administrators regarding the network, device in question 116, or the like. Based, in part, on the received intelligence, and the policies, NACA 112 provides remedies to device in question 116, directs enforcement point 118 on how to enforce the policy, or the like.

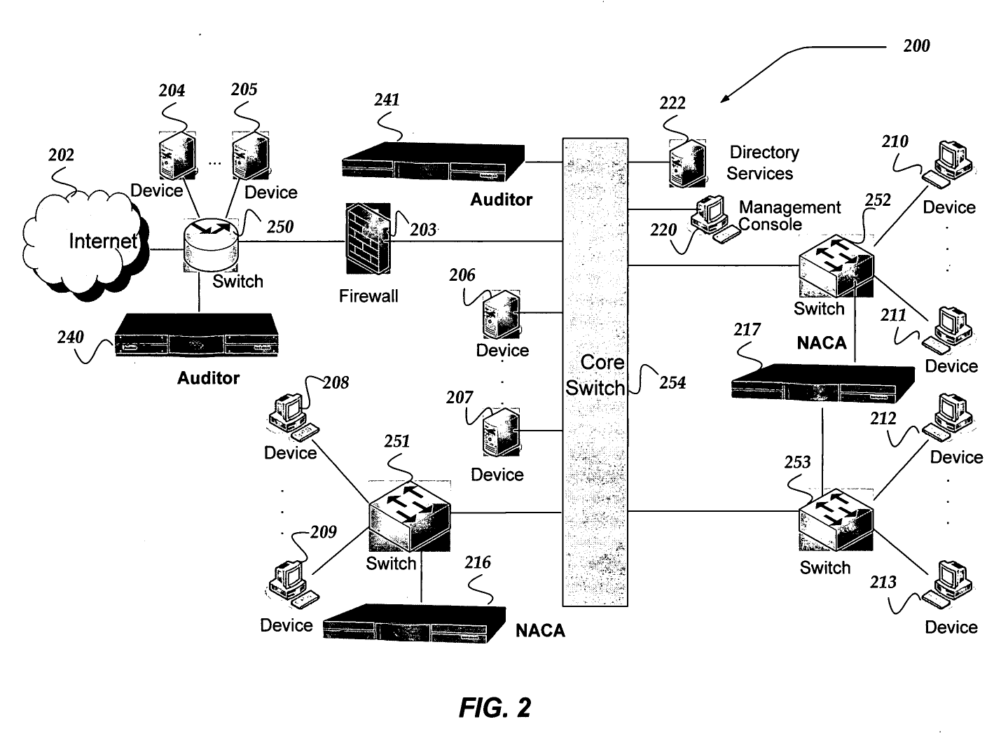

FIG. 2 illustrates one embodiment of an overview of a possible deployment architecture employing at least one NACA. As shown, system 200 includes devices 204-213, switches 250-253, core switch 254, auditors 240-241, NACAs 216-217, firewall 203, Internet 202, directory services 222, and management console 220.

As illustrated, switch 250 is in communication with Internet 202, devices 204-250, firewall 203, and auditor 240. Switch 251 is in communication with NACA 216, devices 208-209 and core switch 254. Switch 252 is in communication with NACA 217, devices 210-211 and core switch 254. Switch 253 is in communication with NACA 217, devices 212-213 and core switch 254. Core switch is in communication with devices 206-207, firewall 203, auditor 241, directory services 222, management console 220, and switches 252-253.

Devices 204-213 may include virtually any computing device that is configured to receive and to send information over a network. Devices 204-213 may operate substantially similar to device in question 116 of FIG. 1. For example, devices 204-213 may request access to a network through a switch.

Auditors 240-241 represent virtually any computing device that is configured to perform a security assessment (audit) of a device in question, and provide intelligence about the device in question. Auditors 240-241 may operate substantially similar to Auditor 104 of FIG. 1. In one embodiment, the suspect node/device in question may be at least one of devices 204-213.

Directory services 220 represent virtually any computing devices, such as external enterprise directories, that are configured to provide identity and permission information about a device, network and/or user over a network. Additionally, directory services 220 may operate substantially similar to directory services 114 of FIG. 1. Management console 220 represents virtually any computing device that is configured to provide a single point of control of several NACAs, including NACAs 216-217. In one embodiment (not shown), an administrator may be in communication with management console 220.

Switches 250-253 and firewall 203 may include virtually any computing device that is configured to control the flow of network traffic. For example, switches 250-253 (and/or core switch 254) may be implemented as a router, bridge, network switch, network appliance, or the like. Switches 250-253 and firewall 203 may operate substantially similar to enforcement point 118 of FIG. 1. For example, switches 250-253 and firewall 203 may be employed to quarantine a suspect node/device in question. Additionally, firewall 203 may include computing devices, such as routers, proxy servers, gateways, or the like that include software filters for shielding trusted networks within a locally managed security perimeter from external, untrusted networks, such as Internet 202. Moreover, core switch 254 may operate to separate, or filter, network traffic between an intranet network and an external network, such as the internet.

NACAs 216-217 may include virtually any computing device that is configured to enable a new device to gain access to a network, and may operate substantially similarly to NACA 112. As shown, NACAs 216-217 may operate on either side of core switch 254, providing support to a network segment within an intranet. In one embodiment, NACAs 216-217 may quarantine a suspect node/device in question by employing at least one of switch 250-253, core switch 254, auditor 240-241, and/or firewall 203. In one embodiment, NACAs 216-217 may quarantine a suspect node/device in question through a firewall, such as firewall 210. NACAs 216-217 may also receive intelligence about a device, and/or user that may indicate policy nonconformance from auditor 240 through firewall 203. NACAs 216-217 may also receive such intelligence from auditor 241 through core switch 254.

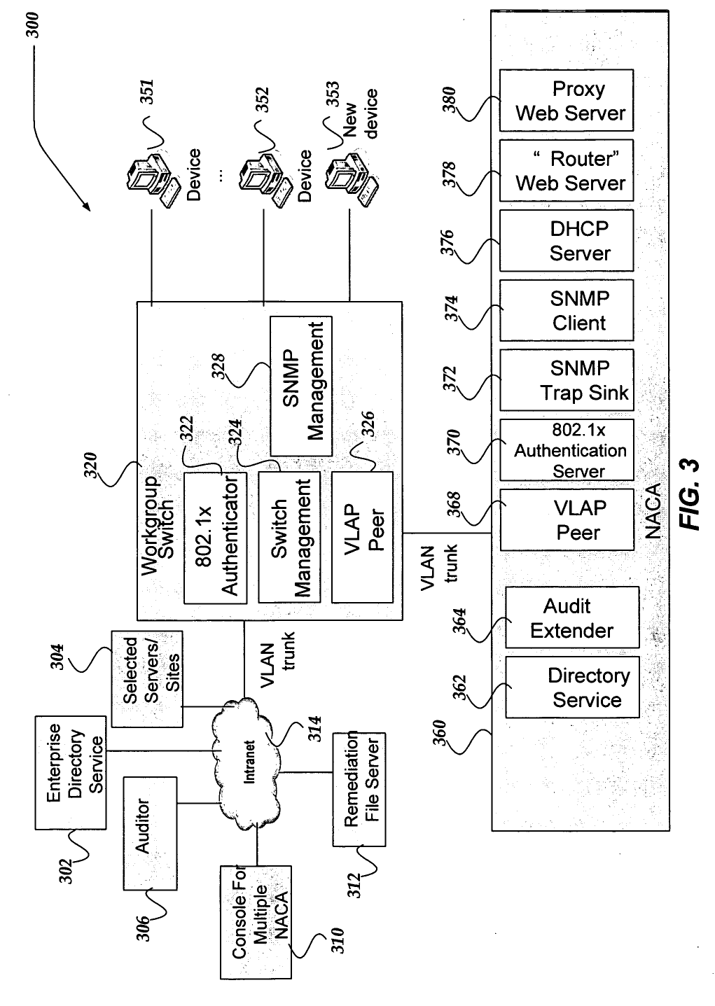

FIG. 3 illustrates one embodiment of one topology of an overview of a possible deployment architecture employing the NACA. As shown, the topology is directed towards avoiding problems that may arise using a conventional 802.1x implementation, including possible disruptions of a business, and manual interventions.

As shown, system 300 includes enterprise directory service 302, selected servers/sites 304, auditor 306, console for multiple NACA 310, remediation file server 312, intranet 314, workgroup switch 320, devices 351-352, new device 353, and NACA 360. Workgroup switch 320 may include 802.1x authenticator 322, VLAP client 326, switch management 324, and SMNP management 328. NACA 360 may includes Simple Network Management Protocol (SNMP) client 374, SNMP trap sink 372, 802.1x authentication server 370, VLAP server 368, proxy web server 380, “router” web server 378, directory service 362, DHCP 376, and audit extender 364.

As shown in the figure, console for multiple NACA 310, auditor 306, enterprise directory service 302, selected servers/sites 304, and remediation file server 312 are in communication with workgroup switch 320 through intranet 314. Intranet 314 enables communication between console for multiple NACA 310, auditor 306, enterprise directory service 302, selected servers/sites 304, and remediation file server 312 and workgroup switch 320. Workgroup switch 320 may be further in communication with a NACA 360. In one embodiment (not shown), console for multiple NACA 310, auditor 306, enterprise directory service 302, selected servers/sites 304, and remediation file server 312 may be in communication with NACA 360 through a communication mechanism, such as a secure channel, a Simple Object Access Protocol (SOAP) connection, a Secure Socket Layer (SSL) connection, or the like. Although not shown, console for multiple NACA 310 may also be in communication with other switches and/or other NACAs substantially similar to the components illustrated in FIG. 2. In one embodiment, as shown, new device 353 is in communication with workgroup switch 320. Devices 351-352 may also be in communication with workgroup switch 320.

Console for multiple NACA 310 may be include virtually any computing device enabled to control at least one NACA, such as NACA 310, and/or other NACAs. In one embodiment, console for multiple NACA 310 may operate substantially similar to management console 220 of FIG. 2.

Auditor 302 represents virtually any computing device that is configured to perform a security assessment (audit) of a device in question, and provide intelligence about the device in question. In one embodiment, auditor 302 performs actions substantially similar to auditor 104 of FIG. 1 and may provide intelligence about a device, and/or user that may indicate policy nonconformance.

Enterprise directory service 302 represent virtually any computing device, such as an external enterprise directory, that is configured to provide identity and permission information about a device, network and/or user over a network. In one embodiment, enterprise directory service 302 performs actions substantially similar to directory services 114 of FIG. 1 and may provide authorization information about a device and/or a user of the device.

Selected servers/servers 304 and remediation files server 312 represent virtually any computing device that is configured to provide remediation information over a network. Selected servers/servers 304 and remediation files server 312 may provide remediation information to a quarantined device substantially similar to resources 106 of FIG. 1.

Workgroup switch 320 includes may include virtually any computing device that is configured to control the flow of network traffic. In one embodiment, workgroup switch 320 performs actions substantially similar to enforcement point 118. The components illustrated within workgroup switch 320 may be employed in quarantining a device, auditing the device, granting the device access to some resources, routing network traffic from the device to a NACA, such as NACA 360, or the like.

Devices 351-353 may include virtually any computing device that is configured to receive and to send information over a network. Devices 351-353 may operate substantially similar to device in question 116 of FIG. 1. Devices 351-352 may be previously audited and authorized devices and may have been granted access to the network. New device 353 may represent a device that has requested access to a network through a workgroup switch 320.

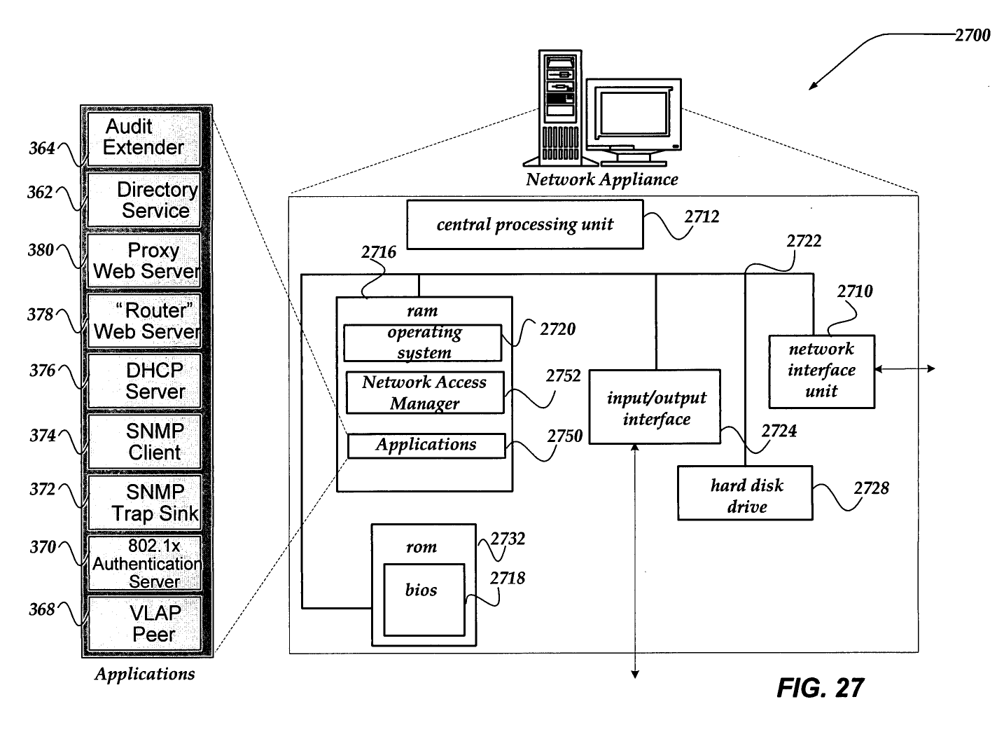

NACA 360 is not limited to the components illustrated within, and more or less components may be implemented within NACA 360, without departing from the scope of spirit of the invention. Moreover, its components may be employed in conjunction with workgroup switch 320 to quarantine a device, audit the device, provide remediation guidance to the device, grant the device access to some resources, or the like. In one embodiment, NACA 360 may be implemented employing a configuration such as is described in more detail below in conjunction with FIG. 27.

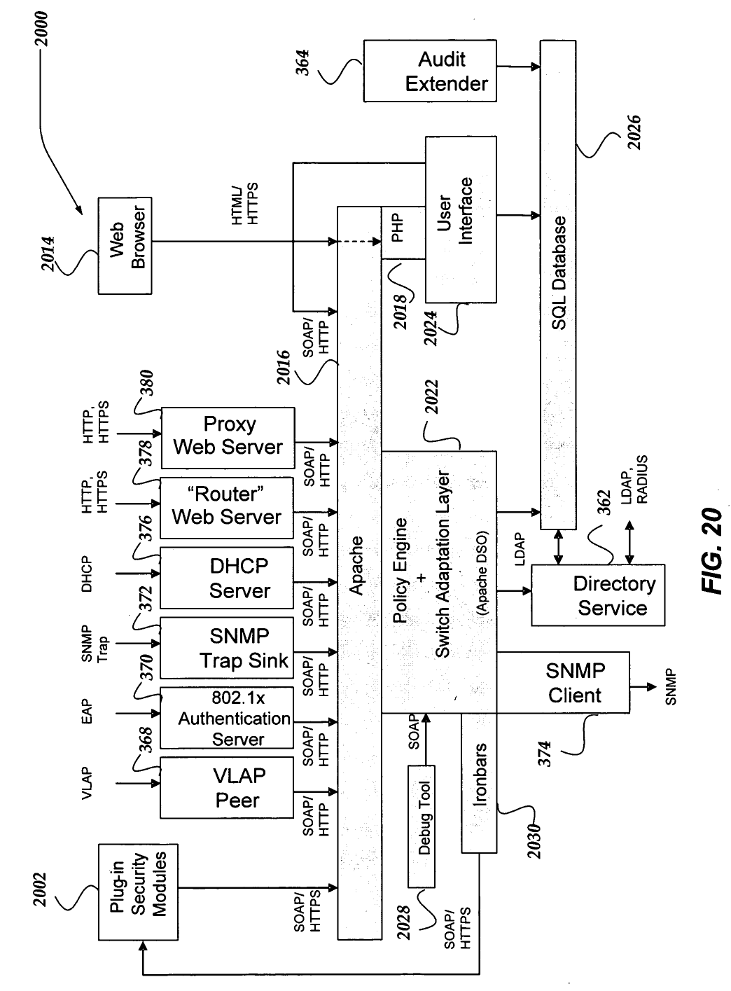

FIG. 20 illustrates one embodiment of an internal architecture for the present invention, wherein a variety of components may be employed. However, while example components are shown, such as Apache 2016, SOAP/HTTP, SQL database 2026, Remote Authentication Dial-In User Service (RADIUS), Ironbars 2030, or the like, the invention is not so limited, and other components that operate substantially similar may be employed instead or in addition to those shown. As shown, system 2000 also includes SNMP trap sink 372, 802.1x authentication server 370, VLAP server 368, proxy web server 380, “router” web Server 378, DHCP 376, Apache 2016, directory service 362, SNMP client 374, policy engine and switch adaptation layer (SAL) 2022, plug-in security modules 2002, debug tool 2028, user interface 2024, PHP 2018, and web browser 2014.

As shown, SNMP trap sink 372, 802.1x authentication server 370, VLAP server 368, proxy web server 380, and “router” web server 378, and plug-in security modules 2002 are in communication with an Apache 2016 via SOAP/HTTP, or the like. Web browser 2014 may be in communication with Apache 2016 via HTML/HTTPS. PHP 2018 may also be in communication with Apache 2016 through an API interface. Directory service 362, SNMP client 374, Apache 2016, debug tool 2028, Ironbars 2030, and SQL database 2026 are in communication with SAL 2022. User interface 2024 may be in communication with PHP 2018 and in further communication with Apache 2016 via SOAP/HTTP. SQL database 2026 may be in communication with audit extender 364 and in further communication with directory service 362 via LDAP.

SAL 2022 may include any computing service enabled to provide a security policy for use in quarantining nodes so that they may be identified, audited, and provided an opportunity to be brought into compliance with the security policy. SAL 2022 may also enable Apache Dynamic Shared Objects (DSO), COM objects, or the like. These objects may implement the logic of SAL 2022. In one embodiment, SAL 2022 in conjunction with SNMP Trap Sink 372, 802.1x Authentication Server 370, VLAP server 368, Proxy Web Server 380, and “Router” Web Server 378, may detect a device seeking to join the network, identify a switch port that the device is attempting to connect to, determine if the device is authentic and authorized to join the network, and as appropriate quarantine the device, grant the device access to the network, or the like. An enterprise security system, such as Ironbars 2030 may be in communication with and control of SAL 2022. Debug tool 2028 may any computing device enabled to monitor and modify the operation of SAL 2022 via SOAP. Directory Service 362 and SQL database 2026 may be in communication with SAL 2022 via LDAP. SQL database 2026 may act as an internal directory service and store any previous audit results/intelligence associated with a suspect device. SQL database 2026 may also store some or all of the security policy information. Correspondingly, audit extender 364 may provide audit results/intelligence to SQL database 2026.

Web browser 2014 may be any web client software and/or device enabled to provide information to a web server such as Apache 2016. Apache 2016 may be an Apache web server but may be any other variety of web server. In one embodiment, web browser 2014 provides the user interface for administering NACA 116 of FIG. 1, providing policies, reporting, remediation guidance, or the like.

Plug-in Security Modules 2002 may also be in communication with Apache 2016 via SOAP/HTTP and may be enabled to direct the security measures associated with SNMP trap sink 372, 802.1x authentication server 370, VLAP server 368, proxy web server 380, and “router” web Server 378, SAL 2022 or the like. PHP 2018 includes any software and/or device enabled to provide the operating logic for Apache 2016. However, any enterprise software may be in communication with Apache 2016, and may provide the logic for the user interface embodying the invention. For example, PHP 2018 may direct user interface 2024 to provide information to, and retrieve information from SQL Database 2026.

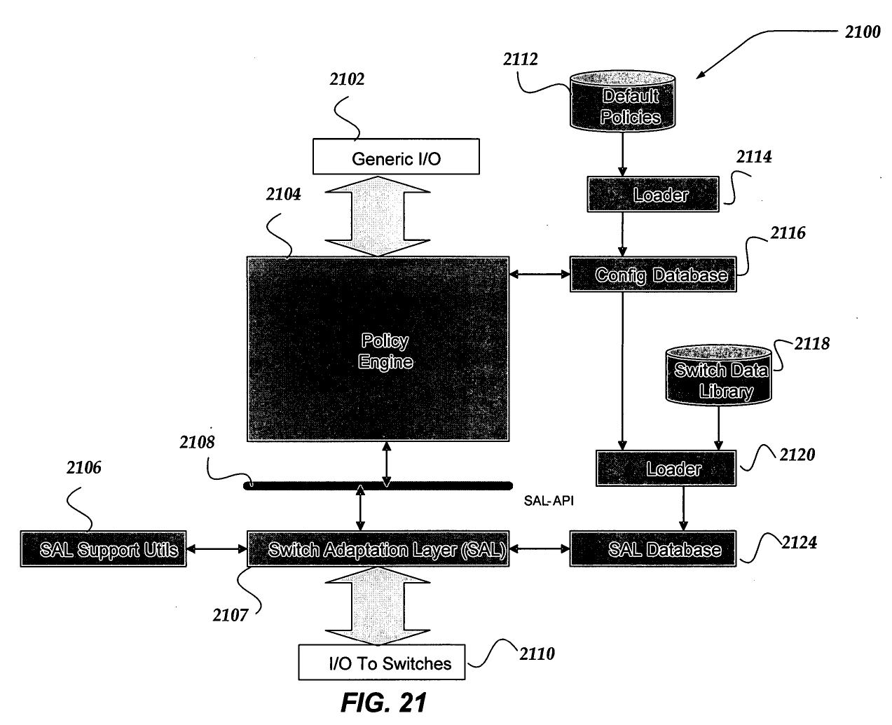

FIG. 21 illustrates one embodiment of an architecture employing a switch adaptation layer (SAL). As shown, system 21000 includes generic IO 2102, policy engine 2104, SAL-API 2108, switch adaptation layer (SAL) 2107, SAL support utilities 2106, I/O to switches 2110, default policies 2112, loader 2114, configuration database 2116, loader 2120, switch data library 2118, and SAL database 2124.

As shown, policy engine 2104 is in communication with generic I/O 2102, such as web browser 2014 of FIG. 20, or the like, configuration database 2116, and SAL-API 2108. Default policies 2112 is in communication with loader 2114. Loader 2114 is in communication with configuration database 2116. Configuration database 2116 is in communication with loader 2120. Loader 2120 is in further communication with switch data library 2118 and SAL database 2124. SAL 2107 is in communication with I/O to switches 2110, SAL-API 2108, SAL support utilities 2106 and SAL database 2124.

In one embodiment, generic I/O 2102, policy engine 2104, SAL-API 2108, switch adaptation layer (SAL) 2107, SAL support utilities 2106, and I/O to switches 2110 may be embodied by SAL 2022 of FIG. 20. Policy engine 2104 may provide its Application Programming Interface (API), user interface or the like via generic I/O 2102. In one embodiment, generic I/O 2102 may provide a user interface for administering NACA 116 of FIG. 1, or the like. Default policies 2112 may operate as a database for storing security policies. In one embodiment, default policies 2112 may operate substantially similar to SQL database 2026 of FIG. 20. Default policies 2112 provide the security policies to loader 2114, which in turn provides information to configuration database 2116. In one embodiment, configuration database 2116 may operate substantially similar to SQL Database 2026 of FIG. 20. Configuration database 2116 may provide security policies and configuration information to policy engine 2104. Configuration database 2116 may also provide information to loader 2120. Switch data library 2118 may also provide information about a switch to loader 2120. In one embodiment, the information may be configuration information, security information, dynamically loaded libraries, objects, or the like, of a switch substantially similar to enforcement point 118 of FIG. 1. SAL database 2124 may receive the information from loader 2120, and provide the information to SAL 2107. SAL support utilities 2106 may also enable various configuration and control of SAL 2017. Policy engine 2104 may control SAL 2107 via SAL-API 2108. Correspondingly, SAL 2107 may provide information to policy engine 2104 via SAL-API 2108. In one embodiment, policy engine 2104 may enable SAL 2107 to detect a device seeking to join the network, identify a switch port that the device is attempting to connect to, determine if the device is authentic and authorized to join the network, and as appropriate quarantine the device, grant the device access to the network, or the like. SAL 2107 may provide its API, user interface or the like, via I/O to switches 2110.

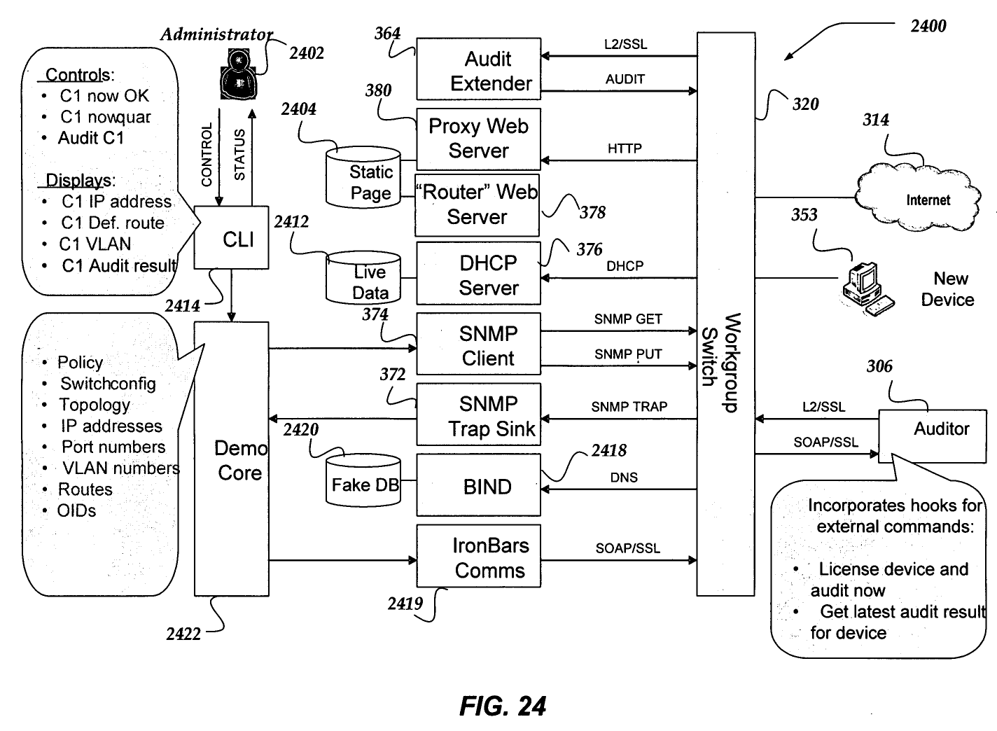

FIG. 24 illustrates one embodiment of an overview architecture for use with a NACA. The topology and components of this architecture is at least substantially similar to the system illustrated in FIG. 3. As shown, system 2400 includes the components of FIG. 3, and administrator 2402, static pages 2404, live data 2412, Control Logic Interface (CLI) 2414, demo core 2422, fake DB 2420, Ironbars Comms 2419, and Berkeley Internet Name Domain DNS server (BIND) 2418.

As shown, SNMP trap sink 372, proxy web server 380, and “router” web server 378, Ironbars comm 2419, BIND 2418, auditor 306 and new device 353 are in communication with workgroup switch 320. Although not shown, VLAP server 368, 802.1x authentication server 370, and directory service 362 may also be in communication with workgroup switch 320. Workgroup switch 320 may be in communication with an internet, such as Intranet 314. CLI is in communication with administrator 2402 and demo core 2422. Demo core is in communication with SNMP client 374, SNMP trap sink 372, and Ironbars comms 2419. Static page 2404 is in communication with proxy web server 380 and “router” web server 378. Live data 2412 is in communication with DHCP server 376. Fake DB is in communication with BIND 2418.

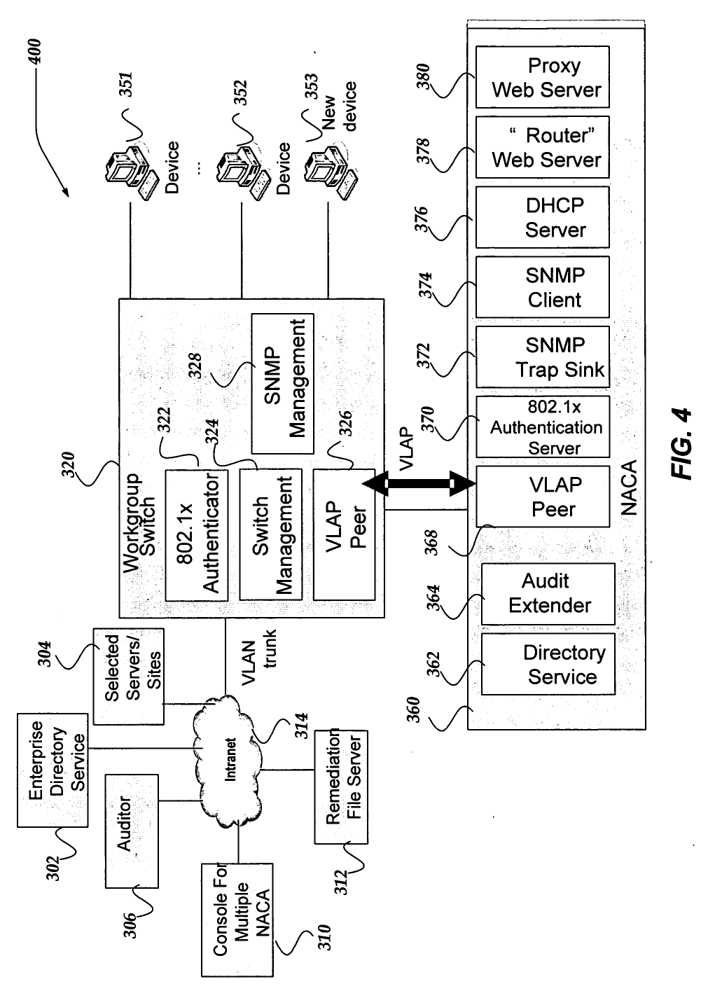

As shown, new device 353 may include any computing device seeking to join a network by linking to workgroup switch 320. BIND 2418 may provide DNS information to Workgroup Switch 320. However, virtually any other DNS servers may be utilized. In one embodiment, fake DB 2420 may provide temporary domain names, IP numbers, DNS information, or the like to the workgroup switch 360. New device 353, and/or other device seeking to join the network may be assigned temporary domain names, IP numbers, DNS information, or the like. In another embodiment, fake DB 2420 may provide such information associated with an intranet, the Internet, an enterprise network, or the like. IronBars Comms 2419 may be virtually any computing device that is enabled to provide security measures for workgroup Switch 360. In one embodiment, IronBars comms 2419 may operate substantially similar to Ironbars 2030. As shown, CLI 2414 may be in device that is enabled to direct demo core 2422 to perform operations as described in conjunction with FIGS. 4-18, and FIGS. 22-23. In one embodiment, demo core 2422 enables policies, switch configuration information, IP addresses, port numbers, VLAN numbers, routes, OIDs, or the like. In one embodiment, the information may be hard coded. In another embodiment, such information may be dynamic and modifiable. CLI 2414 and demo core 2422 may operate substantially similar to SAL 2022 of FIG. 20, and may detect a device seeking to join the network, identify a switch port that the device is attempting to connect to, determine if the device is authenticate and authorized to join the network, quarantine the device, grant the device access to the network, or the like. Administrator 2402 may be any user and/or device that is enabled to provide CLI 2414 with policies, remediation instructions, quarantine instructions, or the like. In turn, CLI 2414 may provide security reports, reports about the current usage of VLANS associated with workgroup switch 320, the default routes enabled by DHCCP server 376, audit results/intelligence, or the like to administrator 2404.

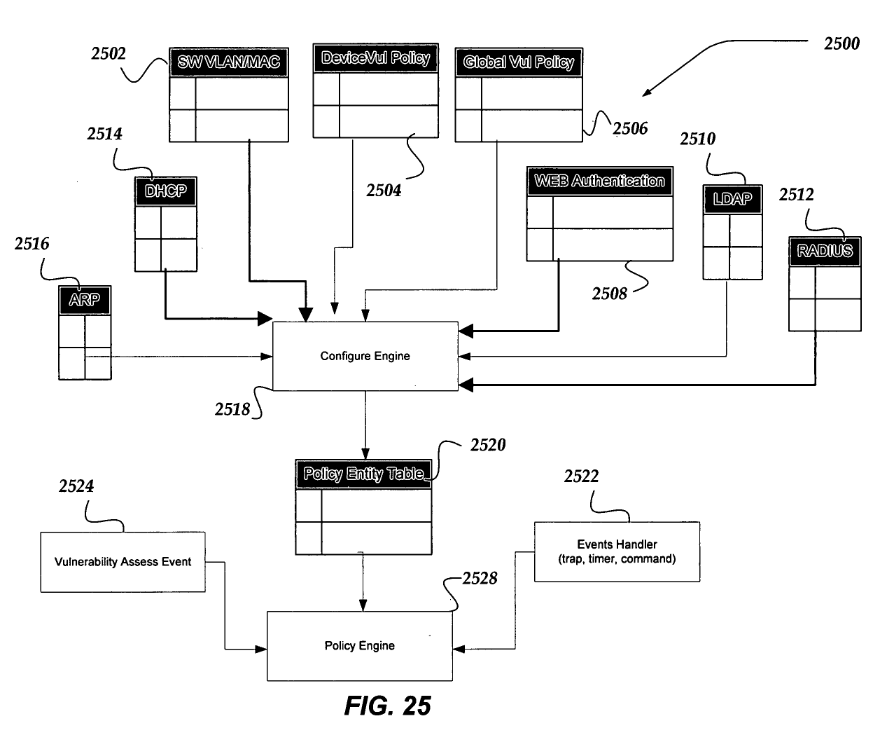

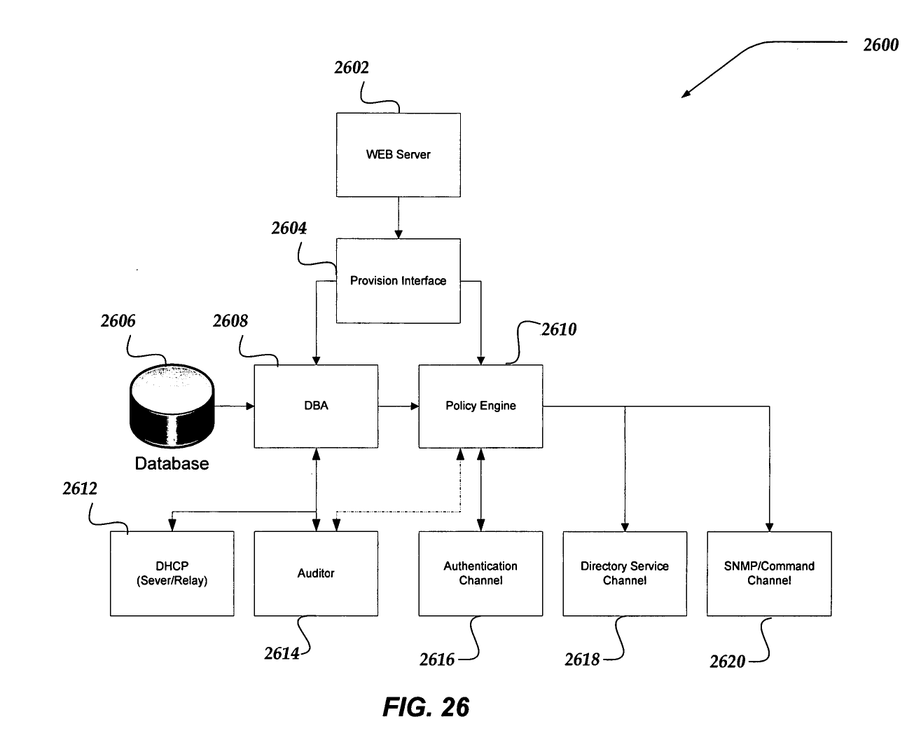

FIGS. 25-26 illustrate embodiments of an overview architecture for managing a policy database for use with the present invention. As shown, system 2500 includes SW VLAN/MAC table 2502, device vulnerability policy table 2504, global vulnerability policy table 2506, DHCP table 2514, Address Resolution Protocol (ARP) table 2516, WEB authentication table 2508, LDAP table 2510, RADIUS table 2512, policy entity table 2520, configuration engine 2518, vulnerability assess event 2524, policy engine 2528, and events handler 2522.

As shown, SW VLAN/MAC table 2502, device vulnerability policy table 2504, global vulnerability policy table 2506, DHCP table 2514, ARP table 2516, WEB authentication table 2508, LDAP table 2510, RADIUS table 2512, and policy engine table 2520 may be accessible by and in communication with configuration engine 2518. Policy entity table 2520 may be accessible by and in communication with policy engine 2528. Additionally, policy engine 2528 is in communication with vulnerability assess event 2524 and events handler 2522.

As shown, a policy database entry may be formed using a listed database, table on the switch, external servers, and internal processes are employed to make two binds, an IP-MAC and a user-IP bind. However, the invention is not so limited, and more or less binds, and well as other binds may also be provided. In one instances, user identity is not required, since an actuator might not be employed to manage a user device.

The policy database includes three areas: vulnerability scan prescription, authentication provision, and a quarantine policy. As shown, vulnerability assess event 2524 enables the vulnerability scan prescription. Events handler 2522 enables authentication provisions, such as detections of traps, timing events, or the like, and the enablement of the control of authentication provisions. Policy engine 2528 enables the quarantine policy, and may operate substantially similar to policy engine 2104, and directs how to interpret vulnerability and authentication results, and a corresponding quarantine action. In one embodiment, the quarantine policy may be enforced using any one or combination of IP, MAC, port address, or the like. Policy engine 2528 may also enable other policies, including authentication policies, auditing schedules, or the like. Policy Engine 2528 receives policy information from policy entity table 2520, which in turn provides the policy information to Configure Engine 2518.

Configure engine 2518 may receive information from various configuration sources which may enable the configuration of the authentication policies, auditing schedule, quarantine policies or the like. Configuration Engine 2518 may also operate substantially similar to Policy Engine 2104 of FIG. 21, SAL 2022 of FIG. 20, or the like. Configuration engine 2518 may receive configuration information from various database tables: ARP table 2516, DHCP table 2514, SW VLAN/MAC table 2502 which contains VLAN and MAC address information, device vulnerability policy table 2504 which contains device vulnerability policies, global vulnerability policy table 2506 which contains global vulnerabilities policies, WEB authentication table 2508, LDAP table 2510, and RADIUS table 2512.

FIG. 26 illustrates that a database may be served by a database administrator (DBA) that warrants synchronization of data, provides an interface to internal modules that may be independent of a data change, or the like. The database may be distributed, in one embodiment. Where DHCP and authentication is distributed, the policy engine may employ a directory service channel to obtain information.

Thus, as shown, system 2600 of FIG. 26 includes web server 2602, provision interface 2604, database administrator (DBA) 2608, database 2606, policy engine 2610, DHCP (server/relay) 2612, auditor 2614, authentication channel 2616, directory service channel 2618, and SNMP/command channel 2620.

As shown, provision interface is in communication with web server 2602, DBA 2608 and policy engine 2610. DBA 2608 is in further communication with database 2606, policy engine 2610, DHCP (server/relay) 2612, and auditor 2614. Policy engine 2610 is also in communication with auditor 2614, authentication channel 2616, directory service channel 2618 and SNMP/command channel 2620.

As shown, database 2606 may be served by a database administrator (DBA) 2608 that warrants the synchronization of the data, provides an interface to internal modules that are independent of a database change, or the like. In one embodiment, database 2606 may contain tables substantially similar to those illustrated in FIG. 25. The database may be distributed, in one embodiment. Web server 2602 may operate substantially similar to proxy web server 380, “router” web server 378 of FIG. 3, Apache 2016 of FIG. 20, or the like. Web server 2602 may provide administrator commands, policies, or the like to provision interface 2604, which may configure the information and route the information to DBA 2608 and policy engine 2610. Policy engine 2610 may operate substantially similar to policy engine 2104 of FIG. 21, SAL 2022 of FIG. 20, or the like. DHCP is enabled by DHCP (server/relay) 2612. Auditor 2614 operates substantially similar to auditor 104 of FIG. 1. Authentication channel 2616 operates substantially similar to VLAP server 368, and 802.1x authentication server 370 of FIG. 3, and may enable the authentication of a new device seeking to join the network. Where DHCP and authentication is distributed, Policy engine 2610 may employ directory service channel 2618 to obtain information, including authentication information about a user and/or a device. Policy engine 2610 may also use SNMP/command channel 2620 to monitor and control a switch on which a new device may be seeking to gain access to a network. In one embodiment (not shown), the switch may be workgroup switch 320 of FIG. 3.

Illustrative Network Appliance

FIG. 27 illustrates one embodiment of a network appliance that may be included in a system implementing the invention, in accordance with the present invention. Network appliance 2700 may include many more components than those shown. The components shown, however, are sufficient to disclose an illustrative embodiment for practicing the invention. In addition, although the invention illustrates use of a network appliance, the invention is not so constrained, and virtually any network computing device may be employed, including a server, or the like.

Network appliance 2700 includes processing unit 2712, and a mass memory, all in communication with each other via bus 2722. The mass memory generally includes RAM 2716, ROM 2732, and one or more permanent mass storage devices, such as hard disk drive 2728, tape drive, optical drive, and/or floppy disk drive. The mass memory stores operating system 2720 for controlling the operation of network appliance 2700. Any general-purpose operating system may be employed. Basic input/output system (“BIOS”) 2718 is also provided for controlling the low-level operation of network appliance 2700. As illustrated in FIG. 27, network appliance 2700 also can communicate with the Internet, or some other communications network, via network interface unit 2710, which is constructed for use with various communication protocols including the TCP/IP protocol. Network interface unit 2710 is sometimes known as a transceiver, transceiving device, network interface card (NIC), or the like.

Network appliance 2700 may also include an SMTP handler application for transmitting and receiving email. Network appliance 2700 may also include an HTTP handler application for receiving and handing HTTP requests, and an HTTPS handler application for handling secure connections. The HTTPS handler application may initiate communication with an external application in a secure fashion.

Network appliance 2700 also includes input/output interface 2724 for communicating with external devices, such as a mouse, keyboard, scanner, or other input devices not shown in FIG. 27. Likewise, network appliance 2700 may further include additional mass storage facilities such as hard disk drive 2728. Hard disk drive 2728 is utilized by network appliance 2700 to store, among other things, application programs, databases, or the like.

The mass memory as described above illustrates another type of computer-readable media, namely computer storage media. Computer storage media may include volatile, nonvolatile, removable, and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computing device.

The mass memory also stores program code and data. One or more Applications 2750 are loaded into mass memory and run on operating system 2720. Examples of application programs include email programs, schedulers, calendars, web services, transcoders, database programs, word processing programs, spreadsheet programs, and so forth. Application programs 2750 may further include those components described below in conjunction with FIG. 3, including SNMP client 374, SNMP trap sink 372, 802.1x authentication server 370, VLAP server 368, proxy web server 380, a router, such as “router” web server 378, directory service 362, and audit extender 364 that is configured to enable an audit across multiple network segments, through a firewall or the like. However, the invention is not limited to these applications, and others may be implemented, without departing from the scope of spirit of the invention. Mass storage may further include network access manager 2752. In one embodiment, network access manager 2752 enables the components of applications 2759 to quarantine a suspected device so that it may be identified, audited, and provided an opportunity to be brought into compliance with a security policy. In one embodiment, network access manager 2752 may operate substantially similar to configuration engine 2518 of FIG. 25, policy engine 2104 of FIG. 21, SAL 2022 of FIG. 20, or the like. Network access manager 2752 may be configured to perform at least those actions described in conjunction with FIGS. 4-19, and FIGS. 22-23.

Generalized Operation

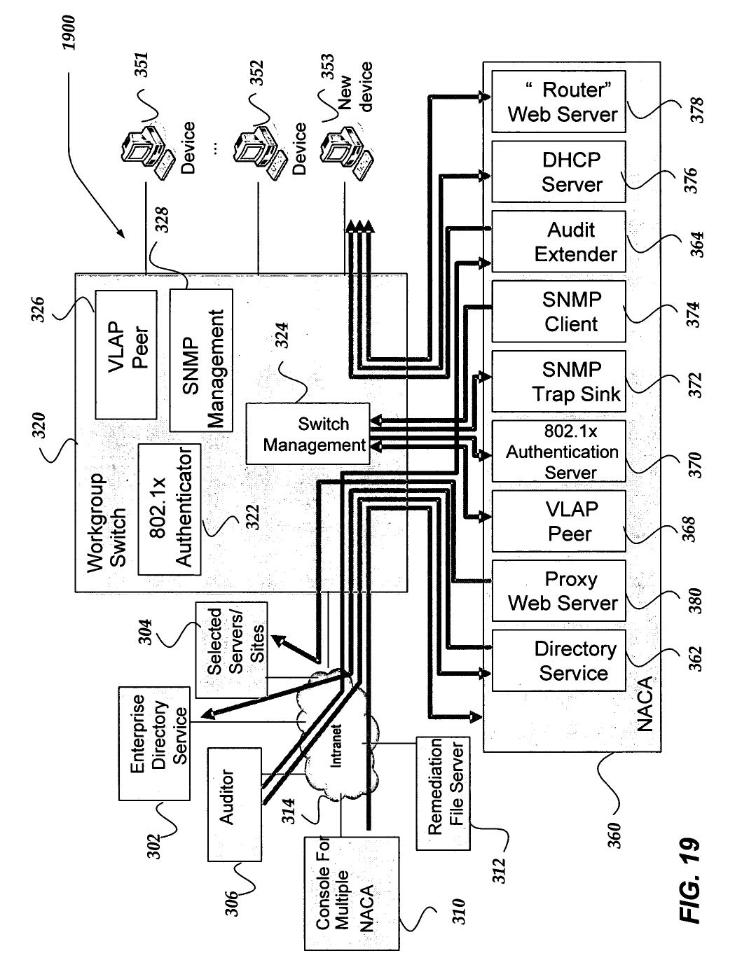

The operation of certain aspects of the invention will now be described with respect to FIGS. 4-19 and FIGS. 22-23. FIGS. 4-18 illustrates embodiments of a process for enabling a new device to seek access to a network. FIG. 19 one embodiment that may be used to summarize the process embodied by FIGS. 4-18. Additionally, FIGS. 4-19 illustrates substantially the same system, topology, and components as described in FIG. 3.

Processing begins at FIG. 4, where NACA 360 detects new device 353's attempt to access or otherwise join the network. Such attempt to access or join the network may be associated with a request to access a resource within the network. Typically, the attempt may include an attempt to access a resource within a network such as an enterprise's intranet, or the like. FIG. 4 illustrates one embodiment of a possible configuration using a Virtual Local Area Network (VLAN) membership policy server. In one embodiment, NACA 360 may employ a VLAP server 326 and VLAP client 368 to detect that new device 353 has requested to join the network based on some VLAP.

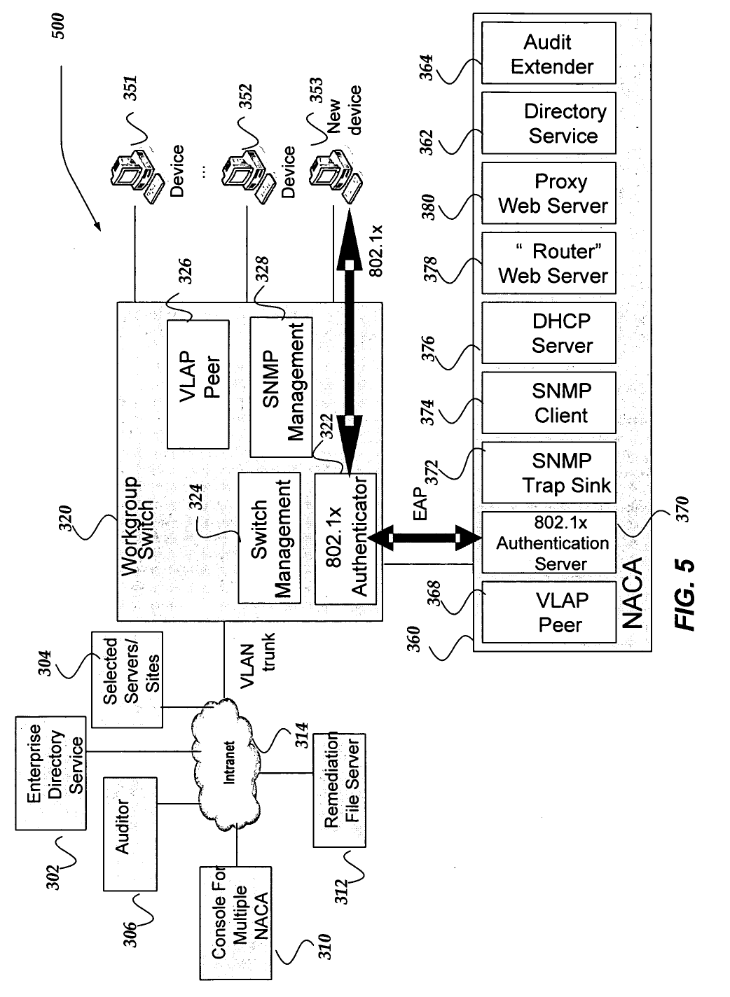

In an alternate embodiment, FIG. 5 illustrates NACA 360 detecting new device 353's attempt to join the network. In one embodiment, workgroup switch 320 is set to employ 802.1x authenticator 322, with NACA 360 as the authenticator. In one embodiment, the 802.1x protocol may be a wireless network access protocol. For example, if new device 353 has successfully been authenticated using an 802.1x protocol, NACA 360 may authorize new device 352 to access or otherwise join the network. However, the invention is not constrained to using 802.1x authentication, and other authentication mechanisms may be employed, without departing from the scope or spirit of the invention.

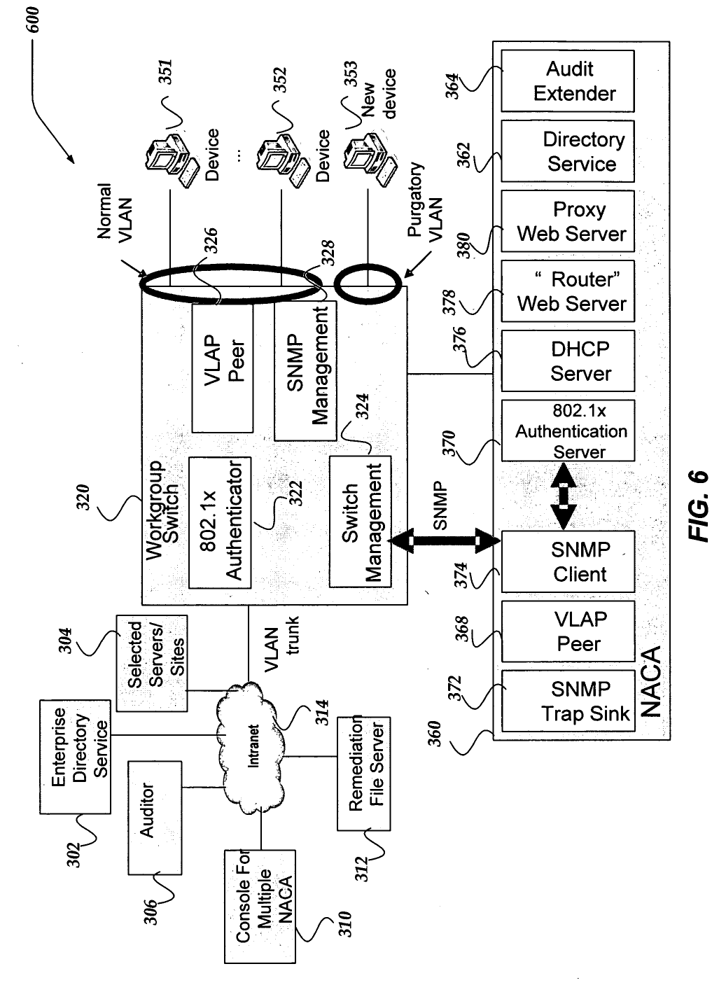

The process then moves to FIG. 6, where NACA 360 employs SNMP client 374, 802.1x authentication server 370, and switch management 324 to read a bridging tale on the switch, and determines a switch port number for a MAC address associated with new device 353. If the MAC address is valid, NACA 360 may enable new device 353's access to the network. In another embodiment, if the MAC address is invalid, NACA 360 may quarantine new device 353, or the like.

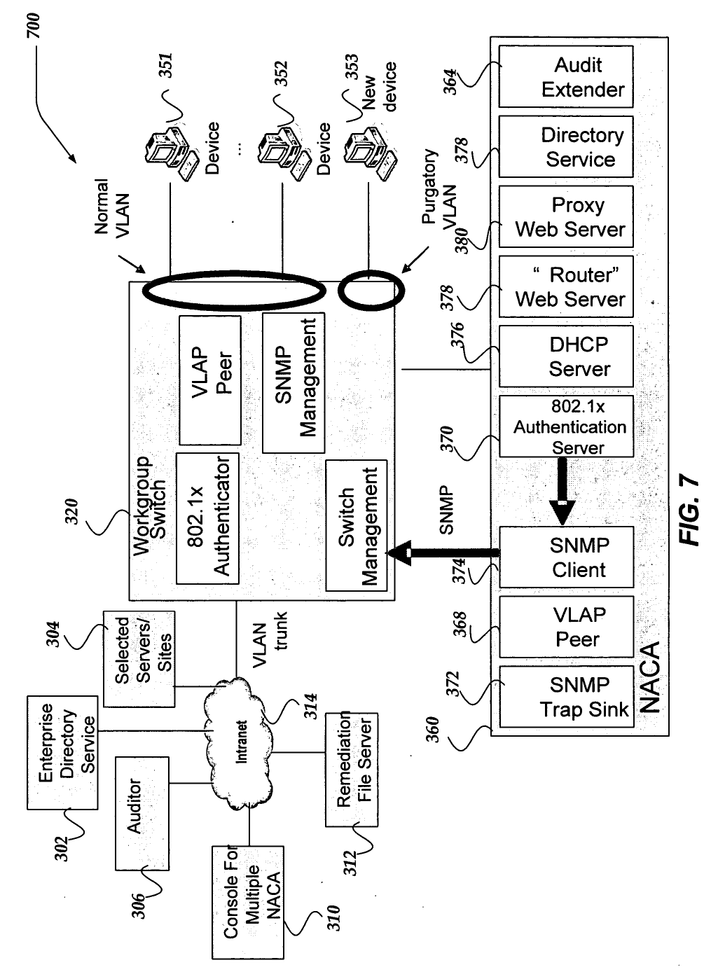

The process continues to FIG. 7, where an authentication mechanism, such as 802.1x authentication server 370, triggers a change in the VLAN assignment for the port, and the switch is reconfigured to enable management by NACA 360. In one embodiment, the authentication mechanism is configured to generally accept virtually all requests. NACA 360 may then quarantine new device 353 by placing new device 353 on a purgatory VLAN. As illustrated, the purgatory VLAN is logically separated from a normal VLAN. In one embodiment, purgatory VLAN may enable access to fewer resources than normal VLAN. For example, purgatory VLAN may enable access to selected servers/sites 304 and/or remediation file server 312.

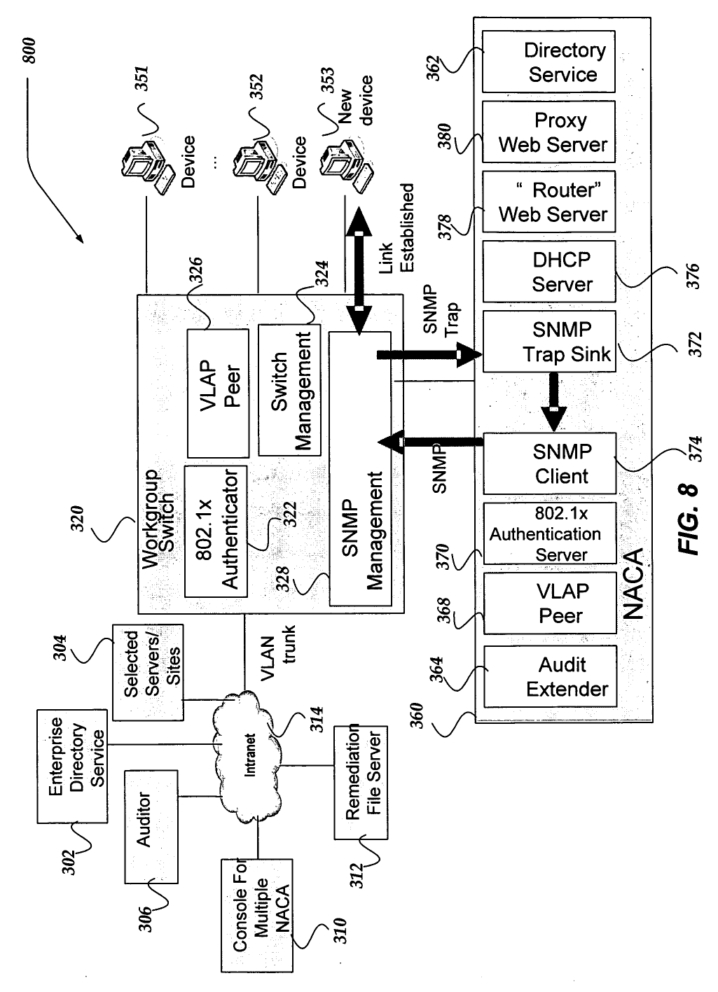

The process then flows to FIG. 8, where an alternative embodiment is illustrated that does not employ an 802.1x protocol. In this embodiment, SNMP traps are employed to detect new device 353's established link. For example, NACA 360 may employ SNMP client 374, SNMP trap sink 372, and SNMP management 328 to detect new device 353's established link. New device 353 may again be placed in purgatory.

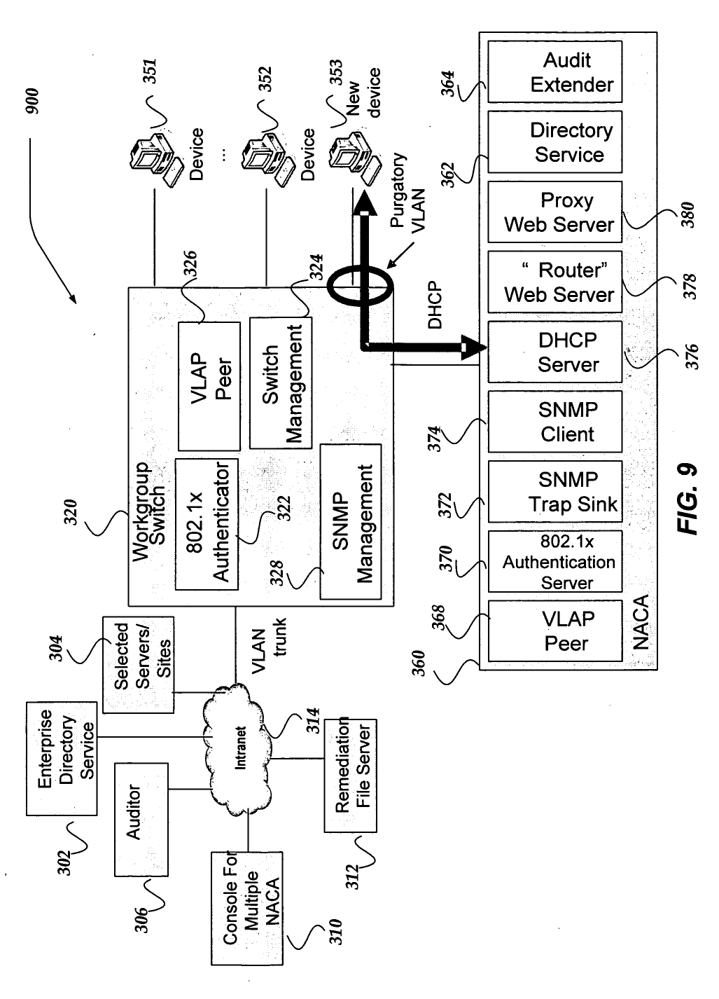

The process continues to FIG. 9, from either FIG. 7, and/or FIG. 8, to where new device 252 is configured with a default route, by NACA 360. As shown, NACA 360, operating as a DHCP server, sets the default route to itself. In one embodiment, NACA 360 employs DHCP server 376 to set the default route to itself

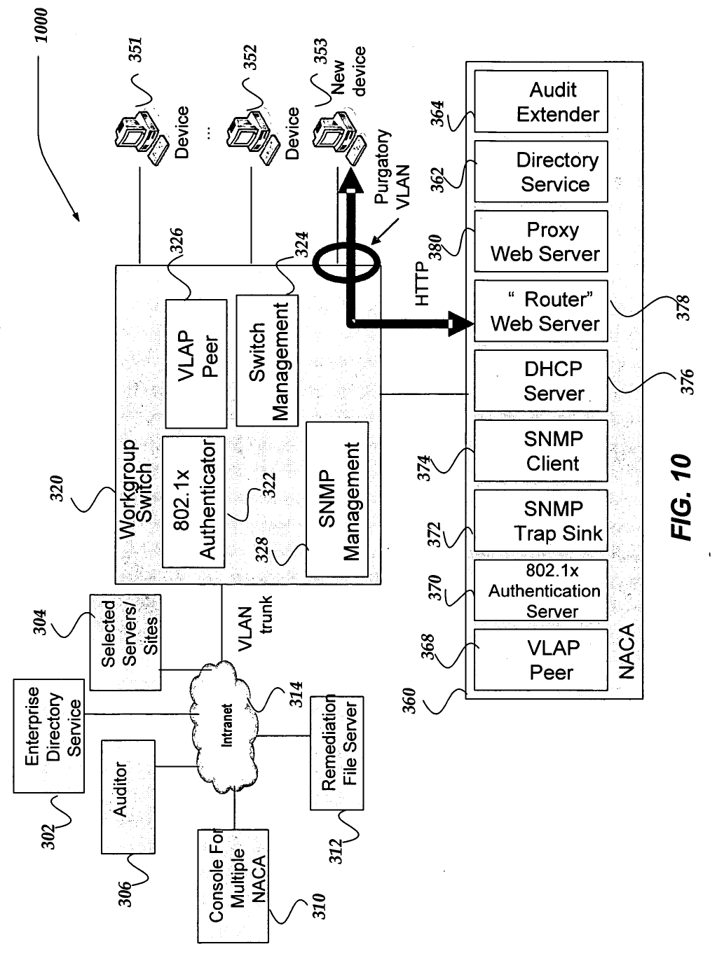

As the process flows to FIG. 10, web traffic may then be steered towards NACA 360. In one embodiment, web traffic may be Hyper Text Transfer Protocol (HTTP) network traffic. Thus, any web traffic goes through the default route. In one embodiment, the default route is through “router” web server 378 that serves all addresses for new device 353. Non-web traffic may be configured to go through NACA 360. In one embodiment, the non-web traffic goes nowhere.

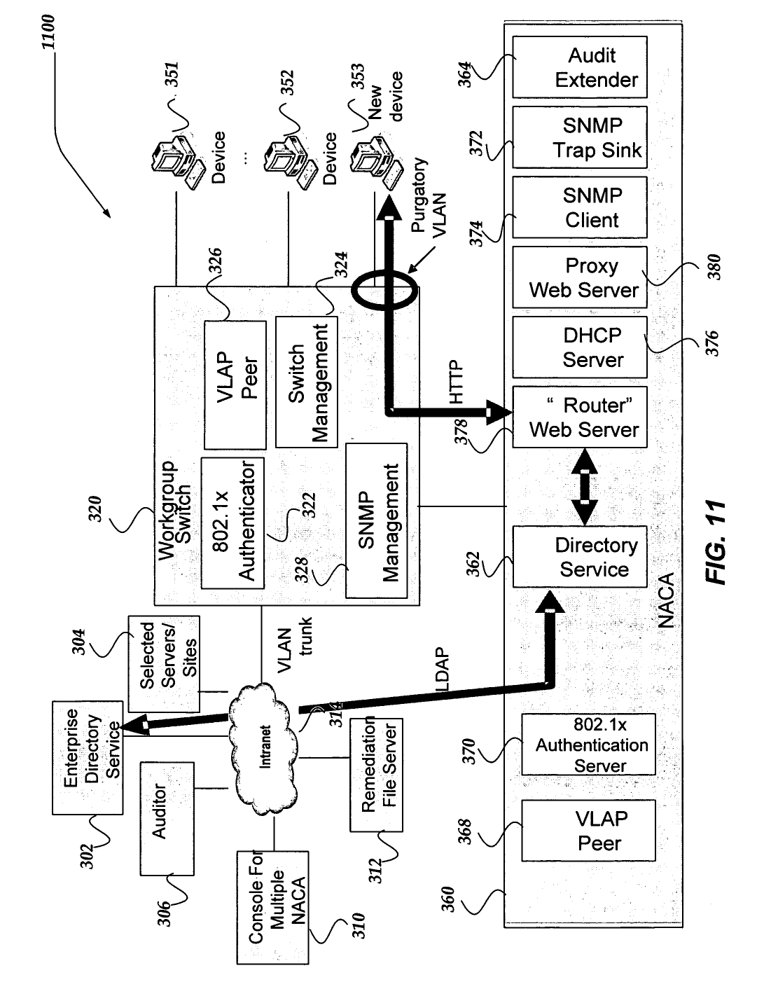

At FIG. 11, new device 353 and/or a user associated with new device 353 is registered. In one embodiment, a registration server checks user credentials and/or device credentials. In one embodiment, “router” web server 378 may act as the registration server, receiving registration information from new device 353 via an HTTP channel, and verifying the validity of the credentials. Interfaces to an external directory service to determine the validity of the credentials may be via Lightweight Directory Access Protocol (LDAP), or the like. For example, enterprise directory service 302 may provide the validity of the credentials to directory service 362 via LDAP. An internal directory service may also be employed to include any previous audit results/intelligence associated with new device 353. Directory service 262 may in turn provide the information to “router” web server 378 so that “router” web server 378 may verify the validity of the credentials.

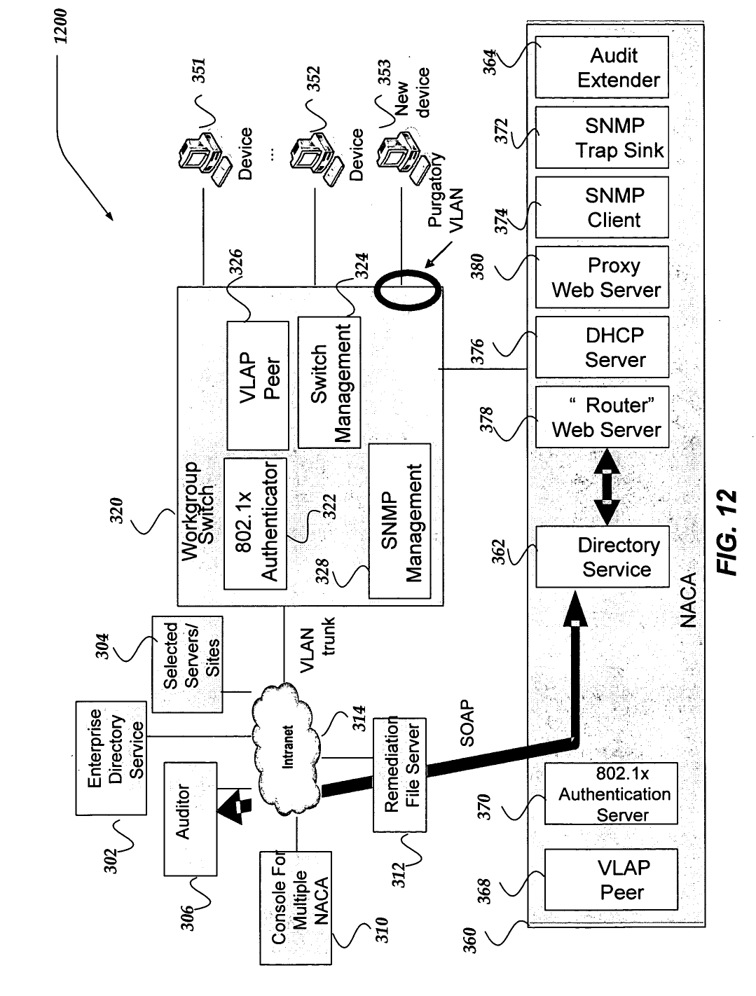

At FIG. 12, a request may be made to audit new device 353. In one embodiment, auditor may provide intelligence to directory service 362 via SOAP about new device 353, and/or the user of new device 353 that may indicate policy nonconformance. The intelligence may also be provided to “router” web server 378, which may in turn provide the intelligence to a device, a user, an administrator, or the like.

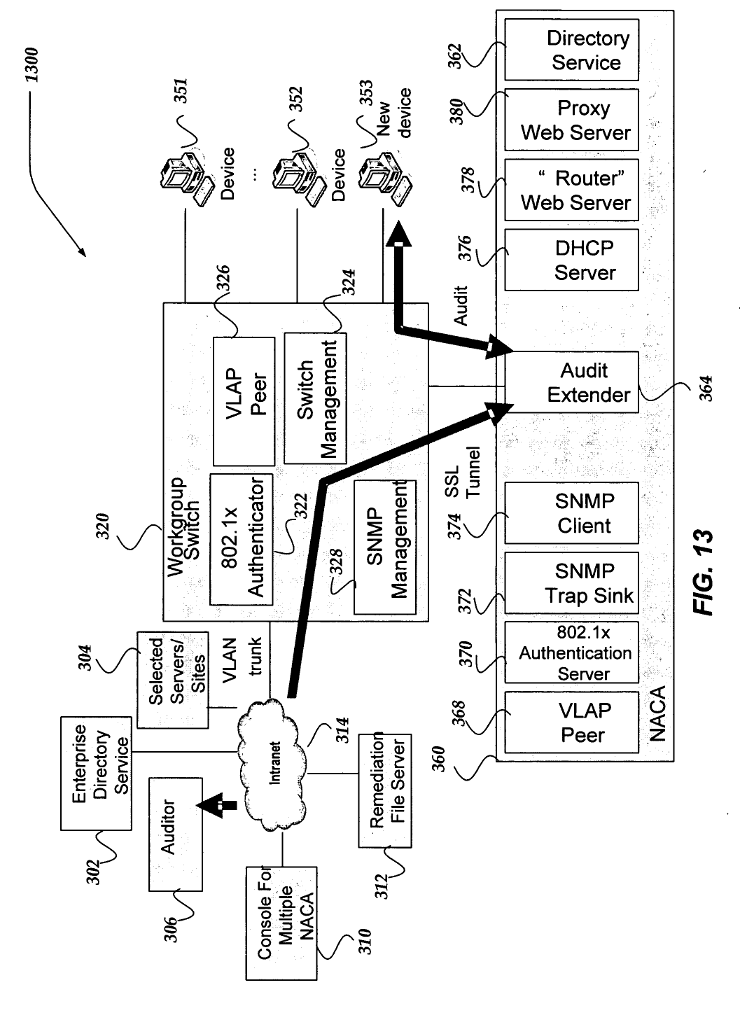

Processing continues to FIG. 13, where an audit mechanism, such as auditor 306, is employed to perform the requested audit. In one embodiment, the audit mechanism may be a sub-component of the NACA. For example, audit extender 364 may act alone, or in conjunction with auditor 306, as the auditor mechanism. Auditor 306 and/or audit extender 364 may provide intelligence about new device 353, and/or the user of new device 353 that may indicate policy nonconformance. In one embodiment, auditor 306 and audit extender 364 are in communication via a secure channel, such as an SSL/TLS channel, or the like. Additionally, auditor 306 and/or audit extender 364 may audit new device 353, through an audit channel, a secure channel such as an SSL/TLS channel, or the like. For example, the audit channel may be the DHCP default route described in FIG. 9.

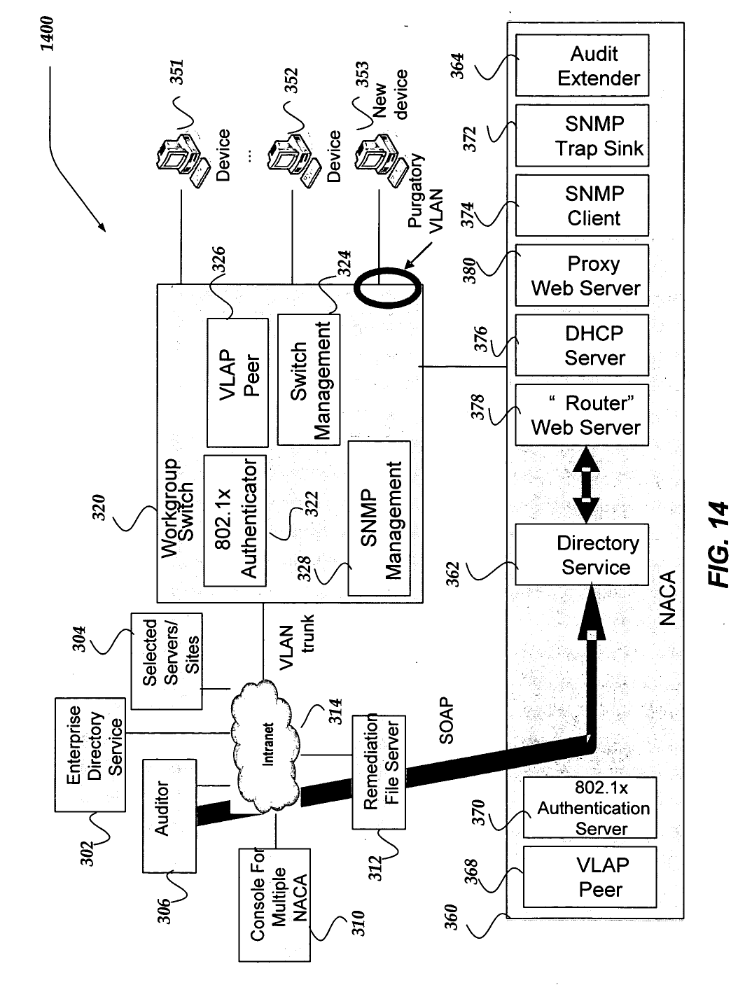

At FIG. 14, illustrates one embodiment of Auditor 306 providing the audit results/intelligence to NACA 360 via SOAP. The invention, however, is not constrained to the use of SOAP, and another mechanism may also be used. The intelligence may also be provided to directory service 362 via SOAP, or another mechanism. In turn, directory service 362 may provide the intelligence to “router” web Server 378.

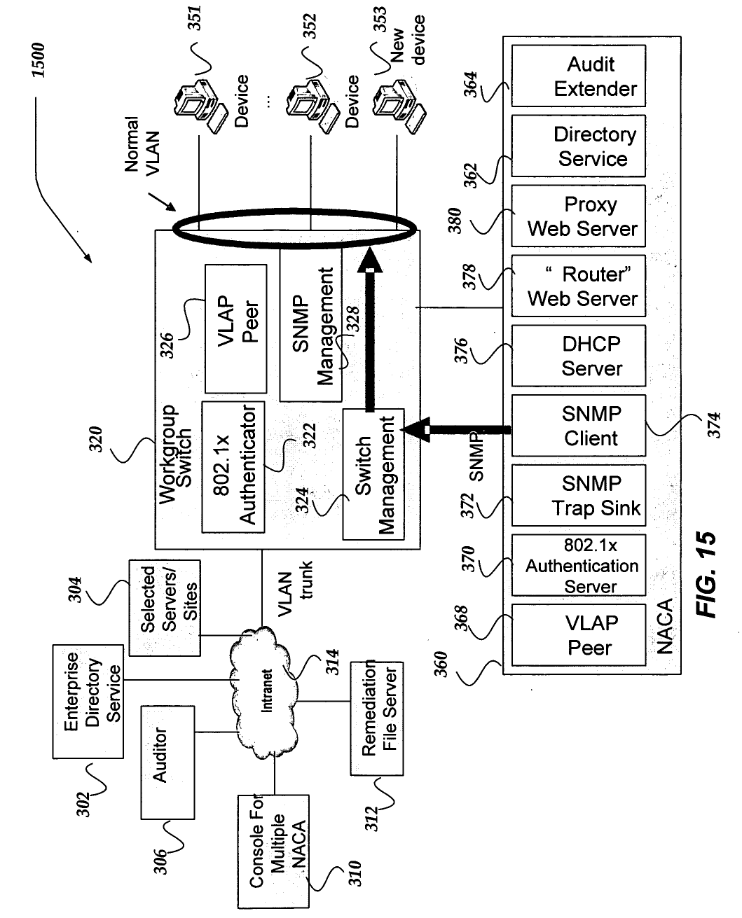

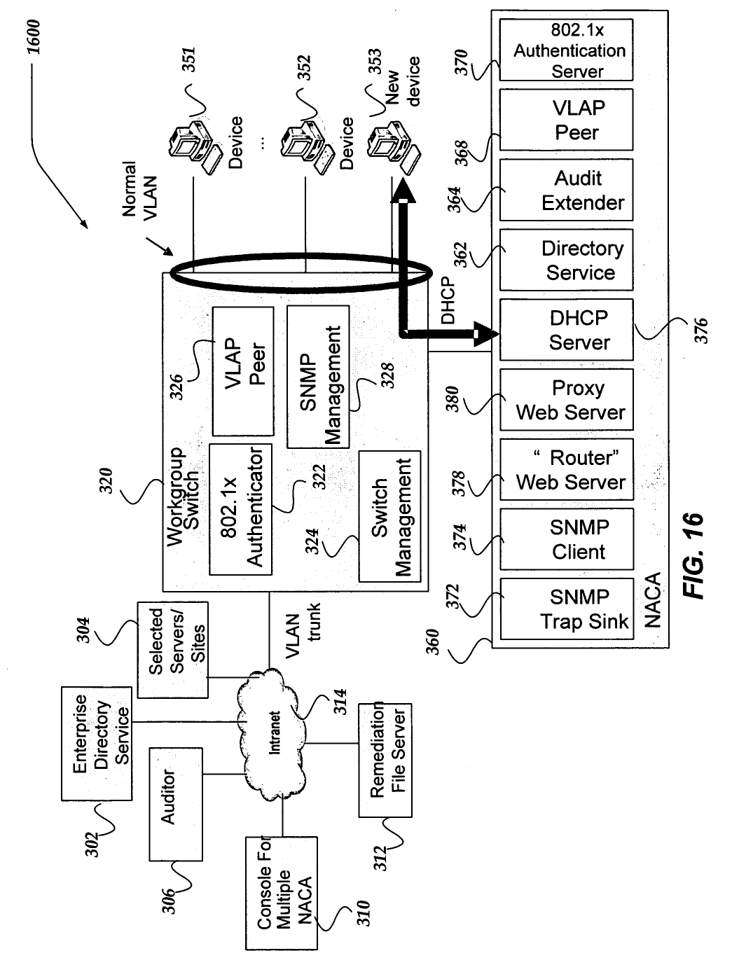

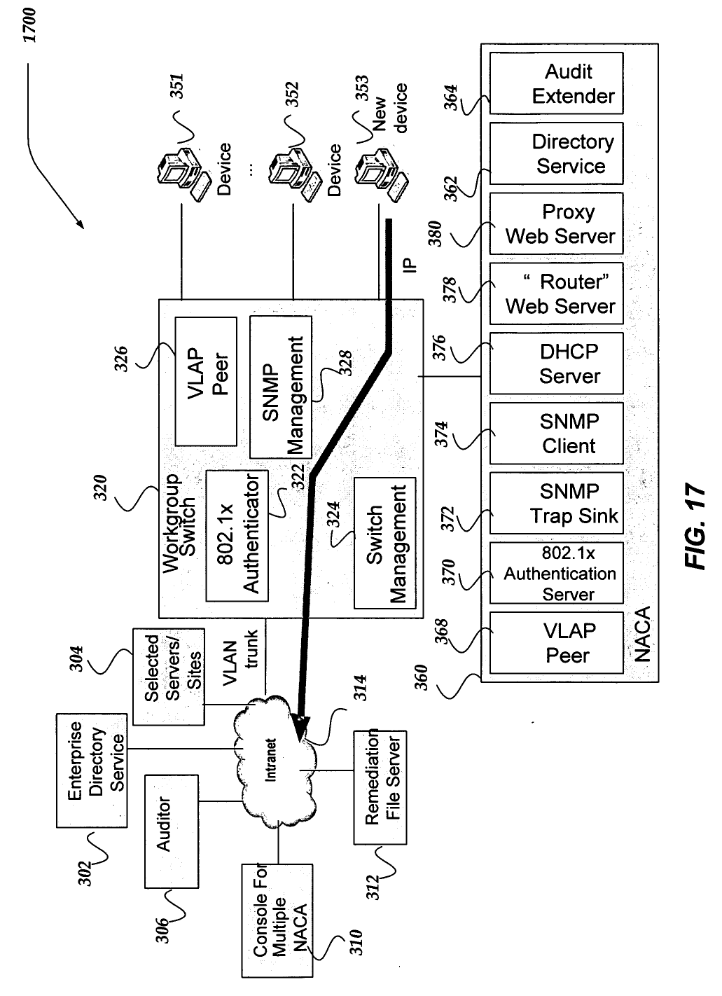

At FIG. 15, if the audit results/intelligence is determined to be satisfactory, new device 353 is accepted, and the port is re-assigned into a normal VLAN. In one embodiment, SNMP client 374 and switch management 324 re-assign the port into a normal VLAN. Processing continues to FIG. 16, where new device 353 then gets new DHCP information from DHCP Server 376 and a proper default route. At FIG. 17, new device 353 then is provided network access.

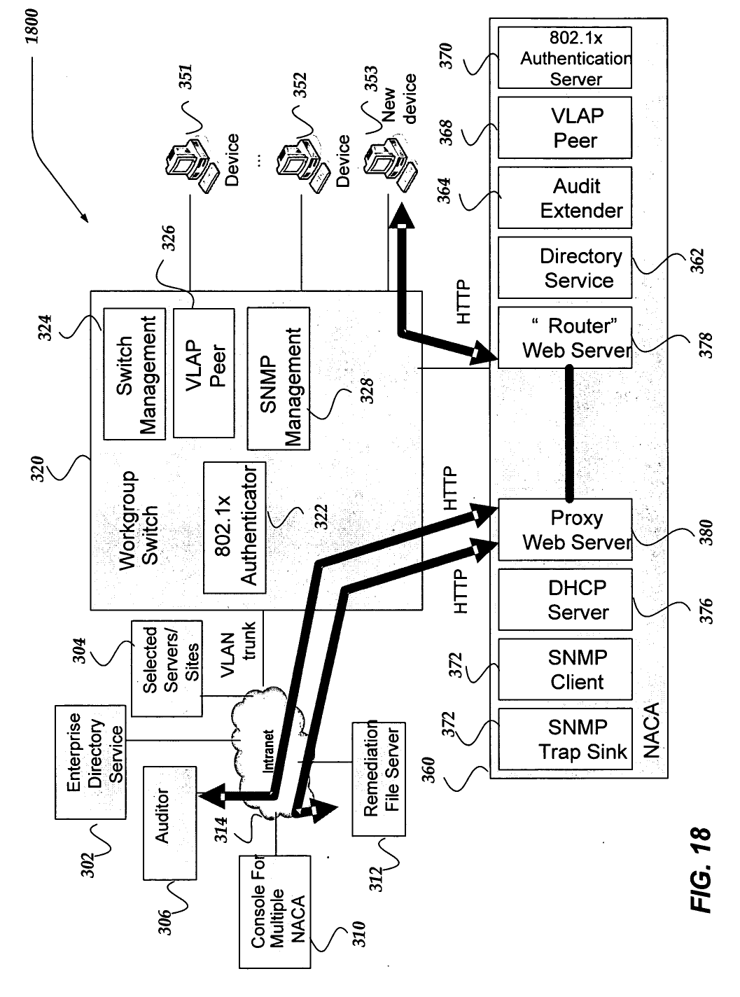

However, at FIG. 18, if it is determined that the audit results/intelligence is unsatisfactory, for any of a variety of reasons, new device 353 is determined to be a vulnerable device, and remediation may be provided. “Router” web server 378 may act as restricted proxy server, in one embodiment, to allow access to remediation instructions, downloads or the like. Proxy web server 380 may also provide remediation guidance. Proxy web server 380 and “Router” web server 378 may direct web traffic from new device 353 to remediation file server 312 and auditor 306. Remediation file server 312 may provide remediation guidance to new device 252 based on the audit results/intelligence provided by auditor 306.

FIG. 19 summarizes the process embodied by FIGS. 4-18. FIG. 19, thus illustrates one embodiment of a solution to providing network access enforcement, in accordance with one embodiment of the invention.

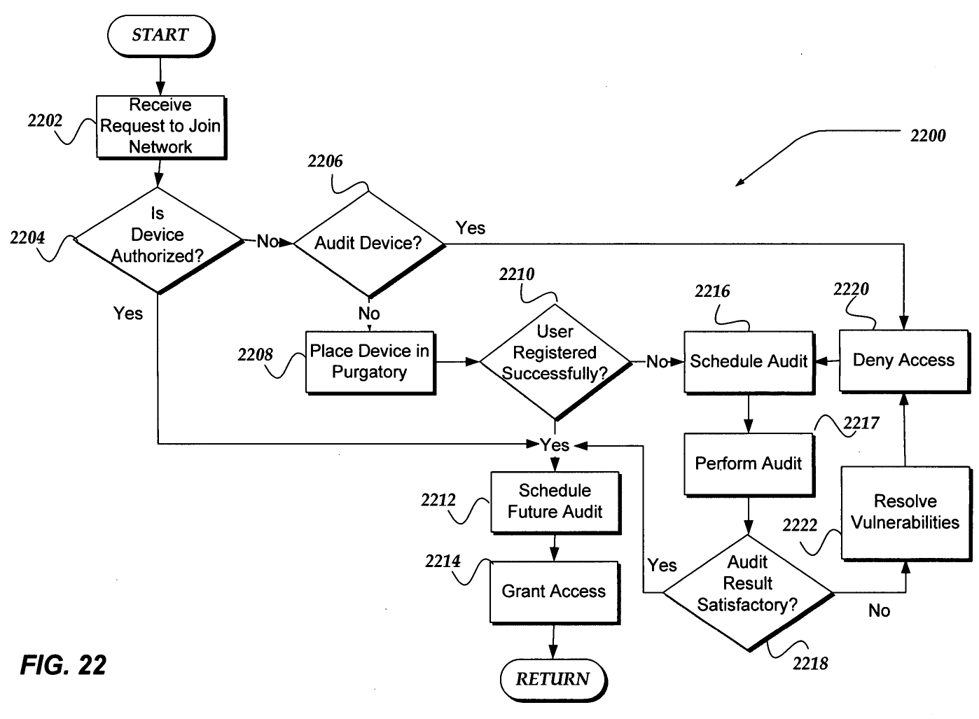

FIG. 22 illustrates a logical flow diagram generally showing one embodiment of a process for managing access control. The logical flow diagram may be employed in conjunction with FIGS. 4-18 described above. Process 2200 of FIG. 22 may be implemented, for example, within NACA 112 of FIG. 1, NACA 360 of FIG. 3, or the like.

Process 2200 begins, after a start block, at block 2202, where a device attempts to access or otherwise join a network. In one embodiment, the device may request to join a network in order to gain access to a resource, such as a server, database, or the like. In one embodiment, the NACA may detect that the device is requesting to join the network and may manage access control at a network switch port level. For example, the NACA may identify the switch port associated with the device.

Processing then continues to decision block 2204, where it is determined if the device is authorized to join the network. In one embodiment, the NACA may quarantine a device/suspect node that is not authorized to connect to the network. In another embodiment, the NACA may quarantine the device that is not authentic and/or authorized to connect to the network. The NACA may determine whether the device is authorized or authentic by at least employing SNMP to read a bridging tale on an enforcement point, determining if a MAC address associated with the device is authorize, performing 802.1x authentication on the device, or the like.

If the determination is that the device is authorized, then the device is granted access to the network and the process flows to block 2212. In one embodiment, the device may be granted access to the some resources on the network. However, if the determination is that the device is not authorized to join the network, then processing continues to decision block 2206.

At decision block 2206, it is determined if an audit is to be performed. The NACA may determine that the device is to be audited based on a user associated with the device not being authorized, a device not having been audited, or not having been audited within a given time period, an audit result/intelligence does not conform to a policy, or virtually any other intelligence about a device, and/or user that may indicate policy nonconformance based on a result or the like. In one embodiment, the NACA may receive such intelligence from Auditor 104 of FIG. 1, Outside Intelligence 110, or the like. The NACA may also be configured to interface to external enterprise directories, such as Directory Services 114, to determine authorization credentials, or the like.

At decision block 2206, it is determined that the device is to be audited, then processing continues to block 2220 where the device is denied access to the network. In one embodiment, the device may be denied access to the some resources, while provided restricted access to another resource. Processing then continues to block 2216 where an audit is scheduled. In one embodiment, scheduling of the audit may result in placing the device into an audit queue, or the like, where the device may wait until it is audited. When it is audited, processing continues to block 2217. In one embodiment, the audit is performed by Auditor 104 of FIG. 1, or Auditor 306 of FIG. 3 and/or Audit Extender 364.

However, if at decision block 2206, the audit is not to be performed on the device, then processing continues to block 2208, where the device may be placed into purgatory where the device may be quarantined. In one embodiment, the NACA may place the device in purgatory by providing a policy that defines which sites/servers or the like, the device may access, and/or how. For example, in one embodiment, placement into quarantine may result in some or all of the device's network traffic being filtered through the NACA, or other device. In one embodiment, the network traffic may be further blocked, redirected, or the like, based on being within quarantined. The NACA may operate with virtually any of a variety of switches, routers, gateways, or the like, to securely quarantine the device. In one embodiment, the NACA employs an enterprise switch to place the device in purgatory. In another embodiment, the NACA may quarantine the device by placing the device on a purgatory VLAN, and sending to the device explanatory information relating to the quarantining the device. The NACA may place the device on the purgatory VLAN by employing at least one of an SNMP trap, VLAP, or an 802.1x protocol to detect a request to join the network by the device, and assigning the device DHCP information which restricts access to the network, or the like. In yet another embodiment, the NACA may place the device in purgatory by providing a VPN-like access control to every internal port. The NACA may also place a device in purgatory by redirecting the device to a friendly web site, a proxy web site, or the like. The friendly web site, the proxy web site, or the like may enable a user, an administrator, a device, or the like, to register, schedule an audit, find audit results/intelligence, and receive remediation information. In one embodiment, network traffic from the device may be routed through the NACA to be examined, filtered, and/or redirected, as appropriate.

Processing next continues to decision block 2210, where a determination is made whether the user and/or device registered successfully. In one embodiment, a registration server checks user credentials and/or device credentials. For example, “Router” Web Server 378 of FIG. 3 may act as the registration server, receiving registration information from the device via an HTTP channel, and verifying the validity of the credentials, and thus the success of the registration. If the user and/or device register successfully, then processing continues to block 2212. Otherwise, processing continues to block 2216.

If at decision block 2210, the user and/or device did not register successfully, then processing continues to block 2216 where the NACA schedules an audit. In one embodiment, the device may be placed into a wait queue to be audited. In another embodiment, the device may be audited almost at once, in which case, processing proceeds to block 2217.

At block 2217, an audit is performed on the device based on a policy. In one embodiment, the audit is performed by Auditor 104 of FIG. 1, or Auditor 306 of FIG. 3 and/or Audit Extender 364. To perform the audit, the NACA may produce an intelligence based on at least one of whether at least one of antivirus detectors, firewalls, or spyware detectors, are installed on the device, running, properly configured, and kept up to date, whether a patch management product is operational and has successfully performed patching actions upon the device, and whether a positive second intelligence about the network is received from an auditing component and/or an outside intelligence component, such as Outside Intelligence 110, or the like. However, the NACA need not receive such intelligence from an auditing component. The NACA may receive intelligence about the network, device in question, or the like, from virtually any source, including an auditor appliance, an anitvirus application, firewall, spyware detector, and even an agent. The NACA may employ policies provided by an administrator, such as Security Administrator 102, and/or Network Administrator 108 shown in FIG. 1, and provide reports regarding the network, device in question, or the like. Processing next continues to decision block 2218

At decision block 2218, it is determined if a result of the audit is satisfactory. In one embodiment, the result of the audit is unsatisfactory if a vulnerability is determined to exist. For example, vulnerabilities may exist if such applications as antivirus, firewalls, spyware detectors, or the like, are not installed, running, properly configured, or kept up to date. If the result of the audit is satisfactory, processing continues to block 2212.

However, if, at decision block 2218, the result of the audit is unsatisfactory, processing continues to block 2222, where an attempt may be made to resolve the unsatisfactory audit result. In one embodiment, the NACA may guide the user associated with the device, an administrator associated with the device, or the device itself to resolve the vulnerabilities, or other unsatisfactory audit result. In one embodiment, resolving the unsatisfactory audit result may include granting the network device restricted access to quarantined devices, deploying a remediation guidance, such as patches and downloads, to the network device, enabling the user associated with the device, the administrator associated with the device, or the device itself to find a result of a previous audit, and enabling scheduling of another audit. Processing then continues to block 2220 where the device is denied access to the network. As described above, processing then continues to block 2216 where audit is scheduled. Processing then proceeds to block 2217, where the scheduled audit is performed.

At block 2212, a future audit may be scheduled for the device. Processing then continues to block 2214, where the device is granted access to the network. In one embodiment, the NACA may grant the device access to the network by placing the device on a normal VLAN. In another embodiment, network traffic from the device might no longer be routed through the NACA. Upon completion of block 2214, process 2200 may return to a calling process to perform other actions.

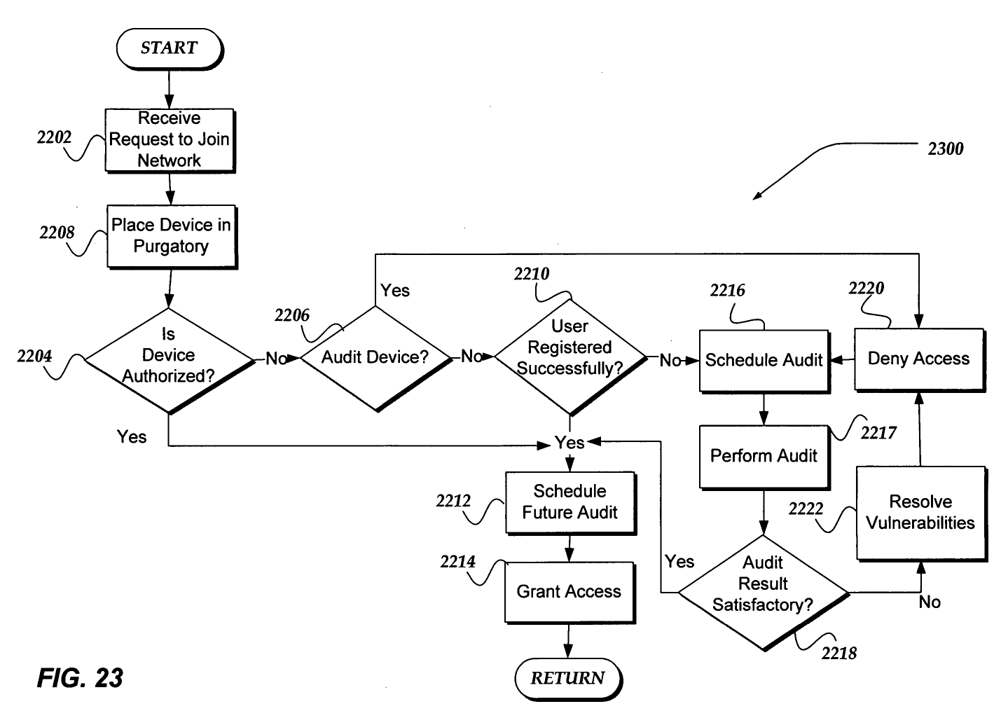

FIG. 23 illustrates another logical flow diagram generally showing one embodiment of a process for managing access, and provides an alternate embodiment for the use of the NACA in conjunction with FIGS. 5-18, as shown above. FIG. 23 is substantially similar to FIG. 22, except that block 2208, where a device is placed in purgatory, occurs after block 2202, where a request to join a network is received from a device, and before decision block 2204, where a determination is made whether the device is authorized to join or otherwise access the network. The other blocks remain substantially the same as in FIG. 22.

It will be understood that each block of the flowchart illustration, and combinations of blocks in the flowchart illustration, can be implemented by computer program instructions. These program instructions may be provided to a processor to produce a machine, such that the instructions, which execute on the processor, create means for implementing the actions specified in the flowchart block or blocks. The computer program instructions may be executed by a processor to cause a series of operational steps to be performed by the processor to produce a computer implemented process such that the instructions, which execute on the processor to provide steps for implementing the actions specified in the flowchart block or blocks.

Accordingly, blocks of the flowchart illustration support combinations of means for performing the specified actions, combinations of steps for performing the specified actions and program instruction means for performing the specified actions. It will also be understood that each block of the flowchart illustration, and combinations of blocks in the flowchart illustration, can be implemented by special purpose hardware-based systems which perform the specified actions or steps, or combinations of special purpose hardware and computer instructions.

The above specification, examples, and data provide a complete description of the manufacture and use of the composition of the invention. Since many embodiments of the invention can be made without departing from the spirit and scope of the invention, the invention resides in the claims hereinafter appended.

What is claimed as new and desired to be protected by Letters Patent of the United States is:

1. An apparatus for managing access to a network, comprising:
a transceiver for receiving and sending information to a computing device;
a processor in communication with the transceiver; and
a memory in communication with the processor and useable in storing data and machine instructions that cause the processor to perform actions, including:
detecting a request to join the network; and
if the device is unauthorized:
placing the device onto a quarantined network,
registering the device, and
performing an audit of the device, and if the device is successfully registered and satisfies the audit, enabling the device to access the network by, at least in part, removing the device from the quarantined network.

2. The apparatus of claim 1, wherein placing the device onto a quarantined network further comprises employing a Virtual Local Area Network (VLAN).

3. The apparatus of claim 1, wherein placing the device onto a quarantined network further comprises routing virtually all network traffic to or from the device through the apparatus.

4. The apparatus of claim 3, wherein routing virtually all network traffic further comprises enabling the apparatus to filter the network traffic based on a security policy.

5. The apparatus of claim 1, wherein placing the device onto a quarantined network further comprises configuring a port on a switch.

6. The apparatus of claim 1, wherein performing the audit further comprises determining at least one of whether a security application is installed on the device, whether a security application is executing, whether a security application is configured based on a policy, or whether an application is at a predefined patch level.

7. The apparatus of claim 1, the actions further comprising:
if the audit is unsatisfied:
denying access to the network, and
providing at least one remediation action to enable the device to at least in part satisfy the audit.

8. The apparatus of claim 1, wherein detecting a request to join the network further comprises employing an SNMP trap or VLAN Assignment Protocol (VLAP) request to detect the request to join the network.

9. The apparatus of claim 1, the actions further comprising:
if the device is successfully registered and satisfies the audit, scheduling the device for another audit.

10. A method for managing access to an intranet by a device, comprising:
detecting a request to join the intranet by the device;
placing the device onto a quarantined network; and
determining if the device is authorized to join the intranet, and if the device is unauthorized:
registering the device, and
performing an audit of the device, and if the device is successfully registered and satisfies the audit, enabling the device to access the network by, at least in part, removing the device from the quarantined network.

11. The method of claim 10, wherein registering the device further comprises determining a credential associated with the device or an end-user associated with the device.

12. The method of claim 10, wherein determining if the device is authorized further comprises at least one of employing an authentication mechanism or validating a MAC address associated with the device.

13. A modulated data signal configured to include program instructions for performing the method of claim 10.

14. The method of claim 10, wherein placing the device onto a quarantined network further comprises assigning the device DHCP information that restricts access to the network.

15. The method of claim 10, wherein detecting the request to join the intranet further comprises, employing at least one of a switch, a concentrator, or an access point.

16. The method of claim 10, wherein placing the device onto a quarantined network further comprises employing an enforcement point that is configured to control a flow of network traffic from or to the device.

17. A system for use in managing access to a network, comprising:
a workgroup switch that is configured to receive a request from a device to join the network; and
an network access control appliance (NACA) that in communications with the workgroup switch and is operative to perform actions, comprising:
detecting a request to join the network from the workgroup switch;
configuring the workgroup switch to place the device onto a quarantined network; and
determining if the device is authorized to join the network, and if the device is unauthorized:
registering the device, and
performing an audit of the device, and if the device is successfully registered and satisfies the audit, enabling the device to access the network by, at least in part, reconfiguring the workgroup switch to remove the device from the quarantined network.

18. The system of claim 17, wherein registering the device further employs an LDAP server.

19. The system of claim 17, wherein the NACA further comprises at least one of an audit extender, directory service, a proxy server, a web server, a DHCP server, an SNMP client, a authentication server, or a VLAP server.

20. A processor readable medium having processor-readable components useable in managing access to a network, the components comprising:
means for detecting a request to join the network;
means for placing the device onto a quarantined network;
means for performing an audit of the device; and
means for enabling the device to access the network by, at least in part, removing the device from the quarantined network, if the device is successfully registered and satisfies the audit.
